(19) United States
(12) Patent Application Publication
(10) Pub. No.: US 2017/0187801 A1
(43) Pub. Date: Jun. 29, 2017

(54) SYSTEMS AND METHODS FOR DATA DISTRIBUTION

(71) Applicant: PENSIVE VENTURES, INC., MIAMI, FL (US)

(72) Inventor: JAVIER A. LUGO, MIAMI, FL (US)

(73) Assignee: PENSIVE VENTURES, INC., MIAMI, FL (US)

(21) Appl. No.: 15/386,387

(22) Filed: Dec. 21, 2016

Related U.S. Application Data
(60) Provisional application No. 62/387,179, filed on Dec. 23, 2015.

(51) Int. Cl. H04L 29/08; G06F 17/30; H04L 12/58

(52) U.S. Cl. CPC H04L 67/1095; H04L 67/1097; H04L 51/24; G06F 17/30345; G06F 17/30557; H04L 67/26; H04L 67/42

(57) ABSTRACT

A distribution server comprising a processor and a database may receive data configured to modify at least one interface of at least one client device and distribution data. The distribution server may store the data in the database. The distribution server may determine each at least one client device to which the data is to be delivered based on the distribution data. The distribution server may synchronize the data in the database with each at least one client device to which the data is to be delivered.

### CROSS-REFERENCE TO RELATED APPLICATION

This application claims priority from U.S. Provisional Patent Application No. 62/387,179, entitled “Systems and Methods for Data Creation and Distribution Involving Keyboard Interfaces,” filed Dec. 23, 2015, the entirety of which is incorporated by reference herein.

### BRIEF DESCRIPTION OF THE DRAWINGS

FIG. 1 is a network according to an embodiment of the invention.

FIG. 2 is a static content distribution process according to an embodiment of the invention.

FIG. 3A is a dynamic content distribution process according to an embodiment of the invention.

FIG. 3B is a dynamic content screenshot according to an embodiment of the invention.

FIG. 4 is a creation, modification, and synchronization process according to an embodiment of the invention.

FIGS. 5A-5E are login and account creation screenshots according to an embodiment of the invention.

FIGS. 6A-6C are template creation screenshots according to an embodiment of the invention.

FIGS. 7A-7D are signature creation screenshots according to an embodiment of the invention.

FIGS. 8A-8B are contact list creation screenshots according to an embodiment of the invention.

FIGS. 9A-9B are clip creation screenshots according to an embodiment of the invention.

FIG. 10 is a library screenshot according to an embodiment of the invention.

FIG. 11 is a group creation screenshot according to an embodiment of the invention.

FIG. 12 is a user creation screenshot according to an embodiment of the invention.

FIG. 13 is an import user screenshot according to an embodiment of the invention.

FIG. 14 is a company profile editing screenshot according to an embodiment of the invention.

FIG. 15 is a user profile editing screenshot according to an embodiment of the invention.

FIGS. 16A-16E are introduction screenshots according to an embodiment of the invention.

FIGS. 17A-17D are account creation and login screenshots according to an embodiment of the invention.

FIG. 18 is a main menu screenshot according to an embodiment of the invention.

FIGS. 19A-19C are template creation screenshots according to an embodiment of the invention.

FIGS. 20A-20E are signature creation screenshots according to an embodiment of the invention.

FIGS. 21A-21C are contact list creation screenshots according to an embodiment of the invention.

FIGS. 22A-22E are clip creation screenshots according to an embodiment of the invention.

FIG. 23 is an account settings screenshot according to an embodiment of the invention.

FIGS. 24A-24C are standard alphanumeric keyboard screenshots.

FIGS. 25A-25P are soft keyboard screenshots according to an embodiment of the invention.

FIG. 26 is a block diagram of an example mobile device configured to implement the features and processes of FIGS. 1-25P.

FIG. 27 is a block diagram of an example server configured to implement the features and processes of FIGS. 1-25P.

FIG. 28 is an example architecture configured to implement the features and processes of FIGS. 1-25P.

### DETAILED DESCRIPTION OF SEVERAL EMBODIMENTS

The systems and methods described herein may be used to provide a user interface (UI) through a soft keyboard on a mobile device and/or through a menu item in a personal computer, for example. The UI may make it easier to communicate by minimizing repetitive tasks. The UI may provide easy access to content directly from a soft keyboard or menu item in a desktop computer. Content may be the user's own content or may be pushed by a manager or content provider, for example. Some embodiments of the systems and methods described herein may address problems unique to the mobile computing field, for example, by providing a soft keyboard with the enhanced features described below. The soft keyboard may be recognized as a keyboard by the mobile device operating system, and may be treated as a soft keyboard by mobile device applications, but may include features allowing for the creation, selection, and/or insertion of content without switching applications. Some embodiments of the systems and methods described herein may address synchronization and distribution of such soft keyboards among multiple users and devices. For example, an organization or group administrator may be able to modify static and/or dynamic soft keyboards. Changes and updates may be automatically pushed to all devices associated with the organization. Accordingly, the systems and methods described herein may solve the technical problem of ensuring that all soft keyboards distributed to organization devices are properly synchronized.

Systems and methods described herein may comprise one or more computers. A computer may be any programmable machine or machines capable of performing arithmetic and/or logical operations. In some embodiments, computers may comprise processors, memories, data storage devices, and/or other commonly known or novel components. These components may be connected physically or through network or wireless links. Computers may also comprise software which may direct the operations of the aforementioned components. Computers may be referred to with terms that are commonly used by those of ordinary skill in the relevant arts, such as servers, PCs, mobile devices, routers, switches, data centers, distributed computers, and other terms. Computers may facilitate communications between users and/or other computers, may provide databases, may perform analysis and/or transformation of data, and/or perform other functions. Those of ordinary skill in the art will appreciate that those terms used herein are interchangeable, and any computer capable of performing the described functions may be used. For example, though the term “mobile device” may appear in the specification, the disclosed embodiments are not limited to mobile devices.

In some embodiments, some or all of the computers used in the described systems and methods may be special purpose computers configured specifically for providing keyboard-based UIs. For example, a mobile device may be equipped with specialized processors, memory, communication components, etc. that are configured to work together to provide keyboard features as described in greater detail below.

In some embodiments, some or all of the computers used in the described systems and methods may be special purpose computers configured specifically for creating and distributing keyboard-based UIs. For example, a manager system and/or distribution server may be equipped with specialized processors, memory, communication components, etc. that are configured to work together to provide creation, editing, distribution, and synchronization features as described in greater detail below.

Computers may be linked to one another through a network or networks. A network may be any plurality of completely or partially interconnected computers wherein some or all of the computers are able to communicate with one another. It will be understood by those of ordinary skill that connections between computers may be wired in some cases (e.g., via Ethernet, coaxial, optical, or other wired connection) or may be wireless (e.g., via Wi-Fi, WiMax, 4G, or other wireless connection). Connections between computers may use any protocols, including connection-oriented protocols such as TCP or connectionless protocols such as UDP. Any connection through which at least two computers may exchange data may be the basis of a network.

The soft keyboard may allow a user to collect frequently used information and recall it from their mobile device keyboard or desktop menu item. The information may be synchronized among all user devices (e.g., associated with a user account) including smart phones, tablets, and desktop systems. Information may be universally available on a mobile device because of the use of a keyboard and in a desktop via a menu item. Thus, the data may be accessed from any application that uses a keyboard, and a user does not have to switch between applications. This may be especially helpful in the context of mobile devices, which may only display one or a small number of applications on screen at once. Indeed, some applications may lose functionality or have reduced functionality when placed in the background, so being able to access data from the keyboard without switching applications may be helpful.

Information may include frequently used texts, images, contact lists, and other compatible digital media, for example. Information may also be pushed to the device by a manager or administrator or pulled to a device from a content provider (e.g., a third party publisher of content such as realtor listings, news articles, stock quotes, etc.).

The information may be captured by the user via a copy operation or entered manually. Information may be captured or retrieved in any device. Devices may synchronize data using a cloud storage database. All devices affiliated with the user may automatically obtain a copy of any newly created data.

In one example, a user (e.g., a manager) may distribute information to a group of individuals. The information does not need to be identical for every user. However, the information may be managed centrally and pushed out to the group. Individual changes for each group member may be made automatically by inserting dynamic content in the central information that may populate with user or device specific data when it is received at the device.

Information (e.g., template items) may be marked as “editable,” so that end users may edit the items when they are received at their devices. Other items may be marked as “use-only,” so that end users may reuse, but not edit, the items when they are received at their devices. Template items may be automatically updated when the original author updates them centrally. An example of an editable item may be a signature template, while a legal e-mail disclaimer in the footer of many messages may be an example of a use-only item. Some items may keep no link to the source, while other items may be linked to the original source and change if the source changes. For example, in some embodiments, editable templates may be edited by the user and may keep no link to the source, while use-only templates may keep a link to the original source and change if the source changes. In the former case, subsequent versions created by the administrator may appear as additional copies on the user system (e.g., different options for the user to select from).

An administrator may centrally manage templates or other content for users. The content may be created by one party centrally and pushed to users in the field. The content may then then appear in the user's interface (mobile or desktop) and could be used through a mobile device's keyboard or desktop client as described herein. Users may be associated with the administrator based on account settings (e.g., employees of a company may have accounts that cause them to receive content from the company's IT department).

Shared items such as templates may contain dynamic content. For example, dynamic content can be a date that automatically changes depending on when the message is viewed (see example below). Another example is the use of geolocation, where content may update depending on geolocation data (e.g., you are 1 mile away or you are close to the destination). Dynamic content may also be populated from data sources (real-time stock quotes, weather, etc.), as well as data source subscriptions (daily quote, etc.). An example may be an e-mail sent by a user to two recipients. The daily quote viewed by one user may be different from the daily quote viewed by the other user since the daily quote may be rendered at the time the e-mail is read.

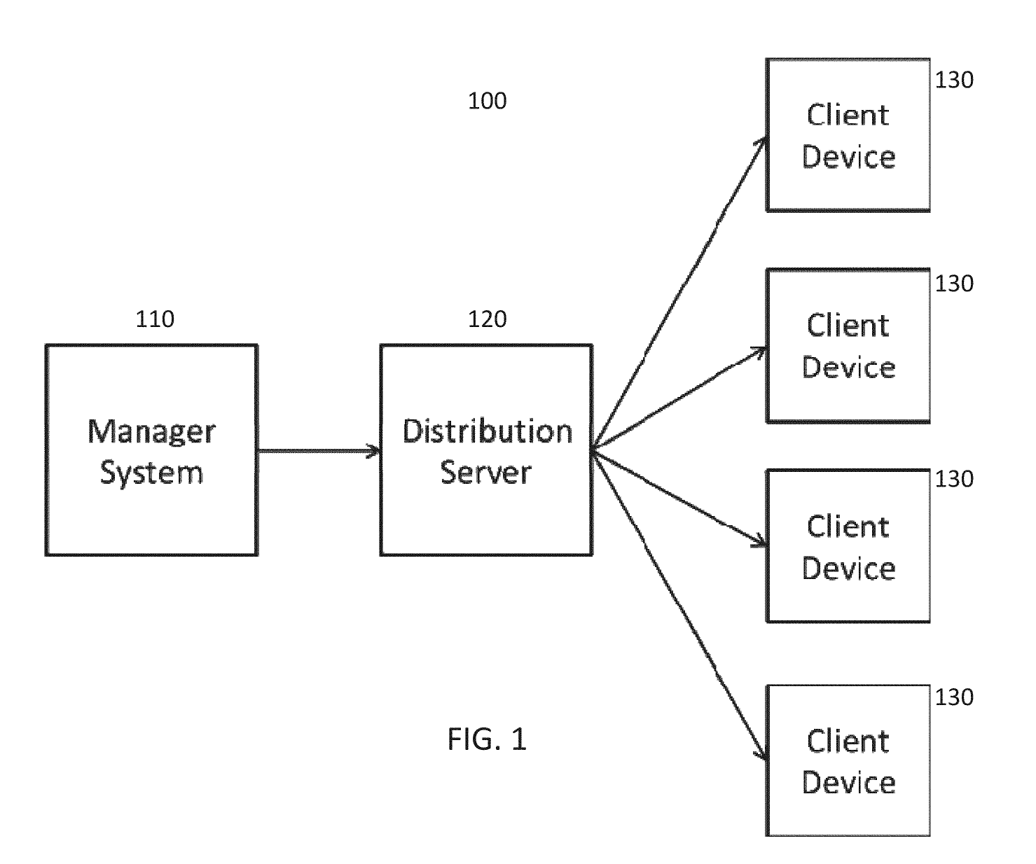

FIG. 1 is an example network 100 configured for distributing and/or managing such content according to an embodiment of the invention. Manager system 110 and distribution server 120 may include specialized hardware and software enabling the creation and distribution of the data (e.g., creation processor of manager system 110, distribution processor of distribution server 120, etc.). Client devices 130 may include specialized hardware and software enabling the viewing, use, and dynamic alteration of the data (e.g., keyboard processor, menu item processor, etc.). In some embodiments, a single device may serve as both a manager system 110 and a client device 130. In other words, the same device may generate content to be pushed to other devices and may receive synchronized content pushed by distribution server 120.

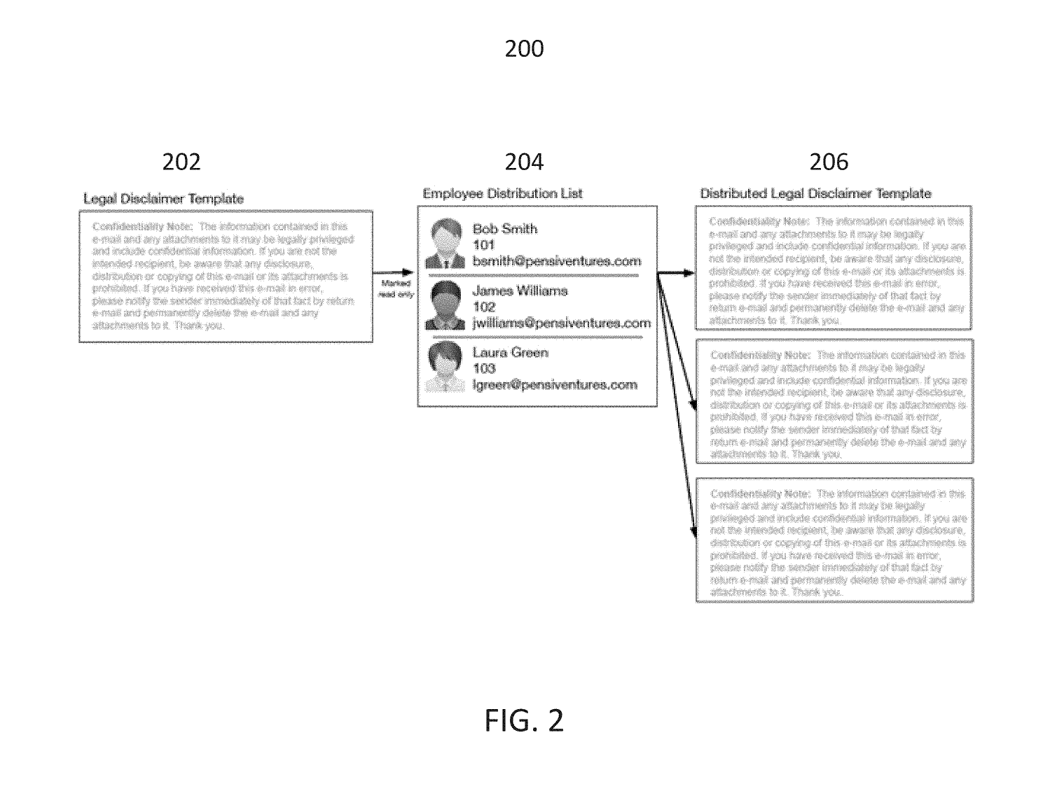

Content may be distributed across network 100. FIG. 2 is a static content distribution process 200 according to an embodiment of the invention. In an example including use-only content without dynamic content, a manager can compose a legal disclaimer for company messages. Other content may be possible, and the legal disclaimer is provided for illustration purposes only. In 202, manager system 110 may receive composition data from the manager user and store it as static content for distribution. The legal disclaimer may be inserted into messages sent by users. The content may be distributed to the users, and the information may be directly accessed by the user from their keyboard once it is pushed to their device.

To facilitate distribution to users, the manager may specify a distribution list of users to whom the content is to be distributed. In 204, manager system may receive manager selection of users and create a distribution list. The distribution list may include user identifying information and/or information identifying one or more devices associated with each user to which the data is to be pushed. In 206, distribution server 120 may push the content to client devices 130 associated with the users on the list.

When changes to the legal disclaimer are made by the manager, the copy of the legal disclaimer on each employee's client device 130 may be automatically updated (e.g., the manager my edit the disclaimer and upload it to manager system 110, distribution server 120 may push the update to client devices 130, and client devices 130 may replace the old disclaimer with the new one).

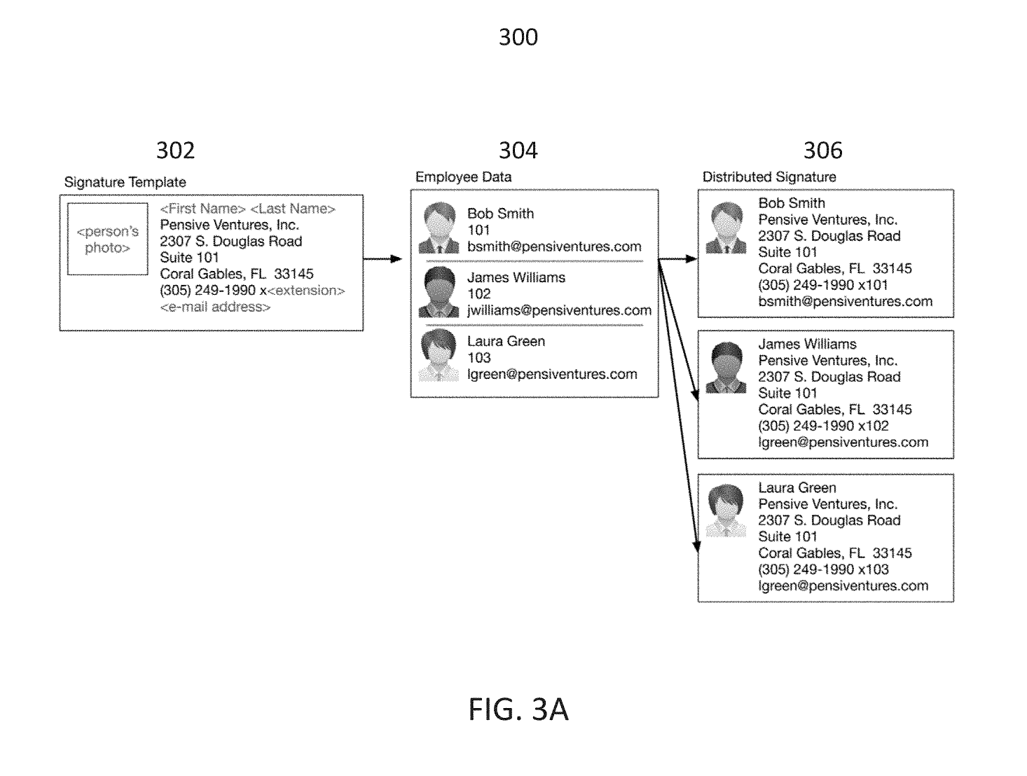

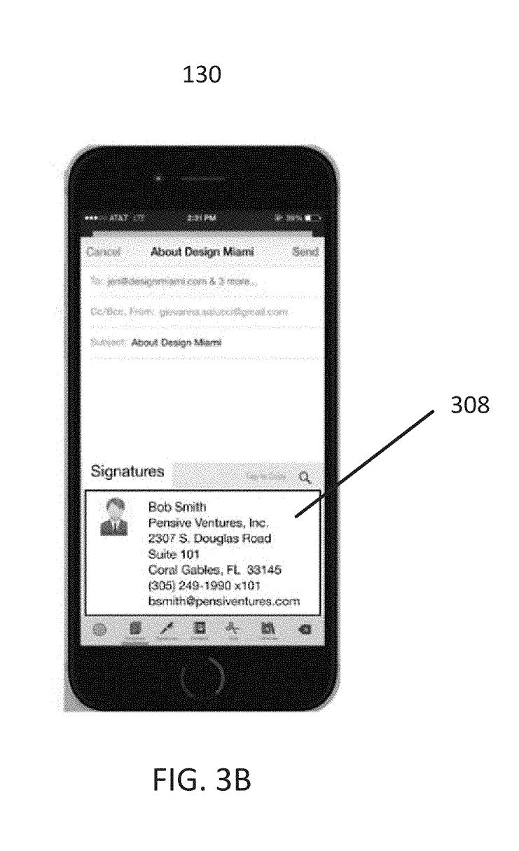

FIG. 3A is a dynamic content distribution process 300 according to an embodiment of the invention. In an example including dynamic content, a manager can compose a template for a company signature. Other content may be possible, and the signature template is provided for illustration purposes only. The signatures may be automatically populated with each individual's name, e-mail address, position, phone extension, and other information specific to the individual. The information may be directly accessed by a user from their keyboard once it is pushed to their client device 130. As shown in FIG. 3B, a standard keyboard (e.g., QWERTY or other alphanumeric soft keyboard) may be replaced with a signature field 308 through which the signature may be selected and added to the message being composed. A user may be able to switch between the selection area and an alphanumeric keyboard within the soft keyboard (e.g., via selection icon at the bottom of the keyboard.

In 302, manager system 110 may receive composition data from the manager user and store it as a dynamic template for distribution. To facilitate distribution to users, the manager may specify a distribution list of users to whom the content is to be distributed. In 304, manager system may receive manager selection of users and create a distribution list. The distribution list may include user identifying information and/or information identifying one or more devices associated with each user to which the data is to be pushed. In 306, distribution server 120 may push the content to client devices 130 associated with the users on the list.

When changes to the legal disclaimer are made by the manager, the copy of the dynamic template on each employee's client device 130 may be automatically updated (e.g., the manager my edit the template and upload it to manager system 110, distribution server 120 may push the update to client devices 130, and client devices 130 may replace the old template with the new one).

Dynamic templates may provide the ability to adjust the information in the template message on client device 130 itself. For example, a template may include static content and dynamic content. The static content may be set by the template creator at manager system 110. The dynamic content may be changeable by client device 130. For example, a template may include text and dynamic content including the current location, date, and time. A client device 130 user may use the template to send an event location to another device. The event invitation may say “tomorrow” instead of the date when it is pasted, since client device 130 may compare the date in the template to the current system date of client device 130 when the snippet is being accessed. Thus, dynamic content may be accessed and presented on a keyboard or desktop menu item prior to using the content. For example, see the following use case wherein a dynamic date element is included in a template:

Today's date is 11/3/2015

Example using a standard paste: You are invited to an event on November 6th.

Example using the soft keyboard (sent today): You are invited to an event on Friday.

Example using the soft keyboard (sent on 11/5): You are invited to an event tomorrow.

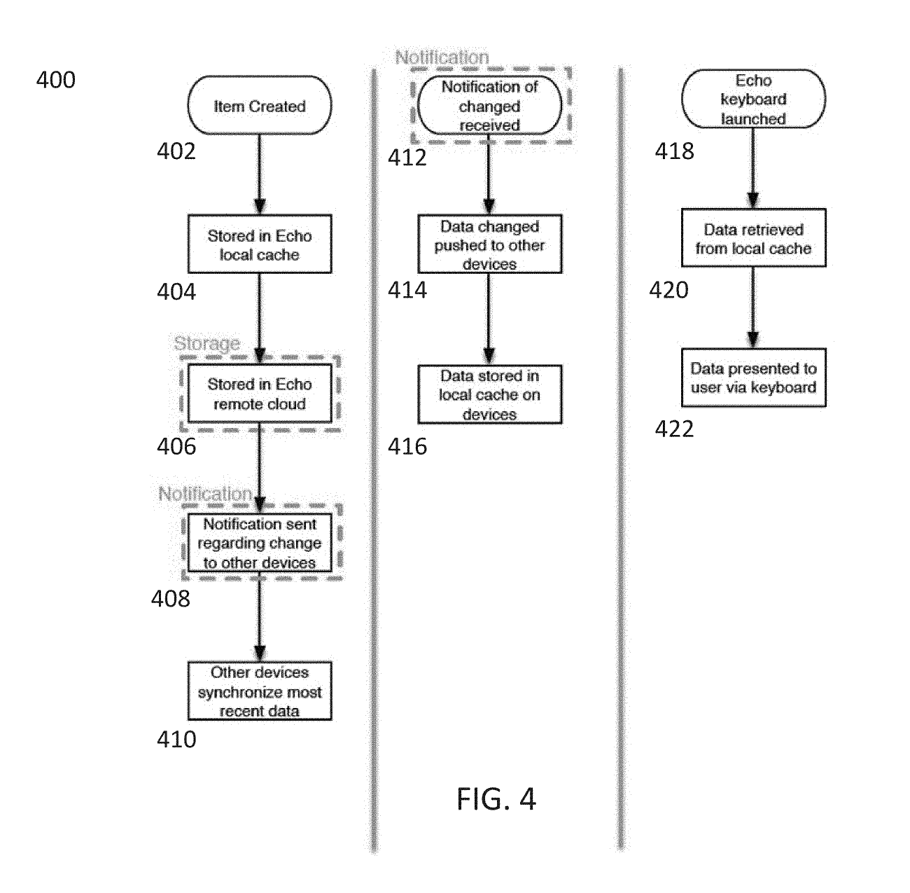

Data may be created by manager system 110, distributed by distribution server 120, and accessed from a keyboard on client device 130 or desktop menu item on client device 130. FIG. 4 is a creation, modification, and synchronization process 400 according to an embodiment of the invention. The left column generally illustrates how backend devices (e.g., manager system 110 and distribution server 120) may perform creation and notification of available updates. The center column generally illustrates how backend devices (e.g., manager system 110 and distribution server 120) and user devices (e.g., client device 130) may perform transfer of updates. The right column generally illustrates how user devices (e.g., client device 130) may process the received updates. However, each column represents an interaction between some or all of the involved devices.

Manager system 110 and distribution server 120 may create and/or modify static and/or dynamic data for distribution to client devices 130. In 402, manager system 110 may receive user input and create an item (e.g., signature). In 404, manager system 110 may store the item in a local cache. In 406, manager system 110 may upload the item to a cloud database (e.g., a database that is maintained by and/or is a component of distribution server 120).

Distribution server 120 may push the item to associated client devices 130. In some embodiments, client devices 130 may periodically synchronize with distribution server 120 to ensure they have copies of the most recent data. When a user creates a new item and uploads it to distribution server 120, in 408, distribution server 120 may send a notification that the item has been stored/changed to client devices 130 (e.g., through email, text, inter-system background notification, a combination thereof, etc.). In 410, client devices 130 and distribution server 120 may synchronize the item. In some embodiments, client devices 130 may pull the item from distribution server 120. In other embodiments, distribution server 120 may push the item to client devices 130.

The changed data may be pushed to client devices 130 (e.g., based on a distribution list as described above) and stored in local storage on those client devices 130. From the perspective of client device 130, in 412, client device 130 may receive the notification. In 414, client device 130 may receive the update pushed by distribution server 120, in some embodiments after acknowledging the notification. In 416, client device 130 may store the update in local memory (e.g., a local storage cache).

In 418, client device 130 may launch a soft keyboard associated with the update in response to a user command or in response to another application attempting to display a keyboard, for example. In 420, data (e.g., the item) may be retrieved from the local storage cache. In 422, the retrieved data may be presented to the user via the keyboard interface.

Some embodiments may include the ability to push content directly to a keyboard. Some examples of this may include financial information, images, religious texts, jokes, weather, and other compatible information. An example may be a realtor accessing directly from their keyboard all their MLS listings that may update automatically and may be easily pasted into an e-mail. The keyboard may serve as a conduit to make information available to the user. Since the keyboard may be available in all applications that accept a text entry, it may provide a convenient medium to present information. Static and/or dynamic data pushed to client device 130 may be read-only or editable by client device 130 depending on a setting established at manager system 110 in some embodiments. In some embodiments, the keyboard through which the content is provided is not a keyboard since users cannot use it to type. It may instead be used to recall information and paste it. The user may be able to switch between the keyboard containing content and a typing keyboard (e.g., a standard keyboard provided with a phone or tablet device). The keyboard may be selectable and made active through a device settings interface. The same features and functionality may be provided via a menu bar item on a desktop computer in some embodiments.

In addition to keyboard-based embodiments, some client devices 130 may include desktop client elements (e.g., menu bar items) that may synchronize with the cloud servers in much the same way as the keyboard elements. These desktop elements may allow the user to access the same features as in the web and mobile clients. The desktop client may run as a menu item within the operating system (MacOS, Windows, Linux, etc.) and may be accessible from any application. The desktop client may also operate as an extension to a browser or an alternate platform. For example, an extension may be developed for Google Chrome and Apple's Safari browsers and/or for Slack, placing the desktop item within the interface for the browser.

### Use Case Examples:

Adding a business signature to an e-mail.

Adding a personal signature to a social media posting.

A Realtor appending an MLS listing easily while composing an e-mail.

A sales person selecting a closing statement from a list of templates.

A sales person easily including a price list as an attachment in an e-mail.

A spiritual advisor appending religious quotes while communicating online.

A manager distributing the latest product specials to sales staff to send to clients.

A campaign manager pushing the latest candidate's quote to operatives in the field.

A business manager sending push notification to employees regarding company financials.

A communications manager pushing latest corporate information for employees to post in their social media profiles (Linkedin, Facebook, etc.).

A user accessing from their desktop computer something they copied on their mobile device.

### Functionality for Soft Keyboard:

The following are example user functionalities that may be provided by client device 130 and/or manager system 110 to facilitate the processes and features described above. The list of functionalities is not intended to be limiting, but rather to show examples of UI elements for the system

### Client Device 130 Application (e.g., iOS Container App):

### Startup:

Include concise application feature description.

Provide streamlined new account creation process.

Provide streamlined login process.

Provide ability to recover password.

Publish acceptable “terms of service” and “privacy document”.

### First Use:

Provide tutorial on application layout and use of buttons.

Provide brief tutorial when on each main page when first used.

### Templates:

Provide ability to create template.

Provide ability to edit template.

Provide ability to search templates by template name.

Streamline tools to create rich text/html templates.

Provide ability to convert clip to template.

Sort templates alphabetically and provide alphabet index when applicable.

Provide ability to change format of templates.

Intelligently identify content type.

Provide ability to delete a template.

Alert user of unsaved changes.

### Contact List:

Provide ability to create a contact list.

Provide ability to edit a contact list.

Provide ability to search contact list by list name.

Sort contact lists alpha alphabetically and provide alphabet index when applicable.

Provide ability to delete a contact list.

Alert user of unsaved changes.

### Signatures:

Provide ability to create a new signature from defined templates using a wizard.

Define three signature templates: image on top, image on left, and text only.

Provide ability to enter a signature free form in HTML and text-only formats.

Provide ability to edit signature.

Provide ability to change template of existing signature.

Provide ability to scale and image in a signature.

Provide basic options to modify and edit image in signature.

Create custom social media icons appropriate to the templates.

Provide ability to preview signature.

Provide ability to search signatures by signature name.

Provide option to advertise Echo (“this signature was created with Echo Keyboard”).

Provide ability to delete a signature.

Alert user of unsaved changes.

### Clips:

Provide ability to capture clipboard items into clips.

Provide ability to save items to templates and named them.

Provide ability to change format of clips.

Sort clips list in chronological order.

Provide ability to capture up to X number of clips (more if paid?).

Provide ability to search clips by content.

Provide ability to delete a clip.

Provide ability to disable automatic capturing of clipboard (option available in settings).

### Libraries:

Create simple sample set of content libraries (news, weather, jokes, animated GIFs, etc.) available to all users.

### General:

Provide settings page with ability to log out, delete account, and change password.

Provide ability to manage user profile (e-mail, name, payment (Apple?), etc.).

Create infrastructure to allow for payment of services (in-app purchases).

Create infrastructure to allow for restriction of features for free account.

Provide ability to share content using iOS native share feature in app.

Provide reliable synchronization between devices.

Allow ability to work offline in the app and keyboard.

Provide local cache of all information including images.

Provide ability to invite others to use Echo.

Text only elements should not require to be pasted and should appear instantly when recalled.

### Client Device 130 Soft Keyboard (iOS Keyboard and Extensions):

### Keyboard:

Provide tutorial on first use, particularly for copying and pasting.

Provide access to all information stored in Echo.

Allow ability to work offline.

### Extension:

Provide extension available in sharing iOS feature that will copy selected content into Clips.

### Today Extension:

Provide Today extension to view latest and save clip and launch Echo.

Client Device 130 and/or Manager System 110 Web and Desktop Application:

### Subscriber Web Interface:

Provide all functionality of iOS container app.

Provide ability to update user profile.

Provide ability to share content with other Echo users.

Provide Team management and distribution features.

### Public Website:

Provide clear descriptions of Echo platform, vision, and features.

Include privacy and use policies.

Include about, download, support, and tutorials links.

Provide account creation and download options.

Include links to press kit.

### MacOS Client:

Provide ability to capture clipboard local and synchronize content.

Provide ability to paste directly from Echo menu (2 clicks).

Provide ability to temporarily disable clipboard capture.

Provide ability to login and quit application.

Provide link to Echo web interface.

### Additional Features:

Index all data and provide deep search across all sections and interfaces.

Identify content accordingly so that actions can be done directly. For example, a phone number when clicked on will prompt user to dial. A URL when clicked on will open Safari.

Provide access to all content from desktop client.

Expand libraries and team features.

### Example User Interface

Web Interface

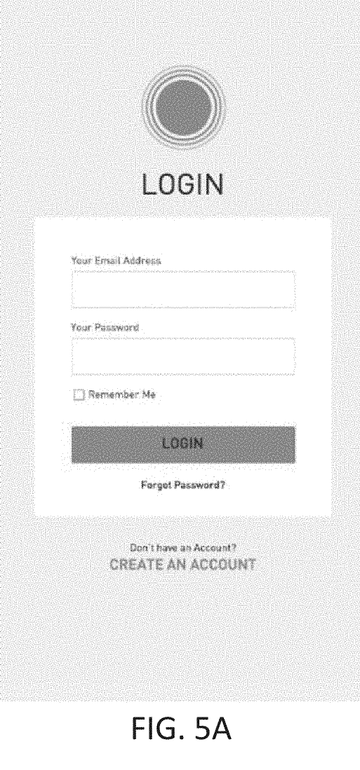

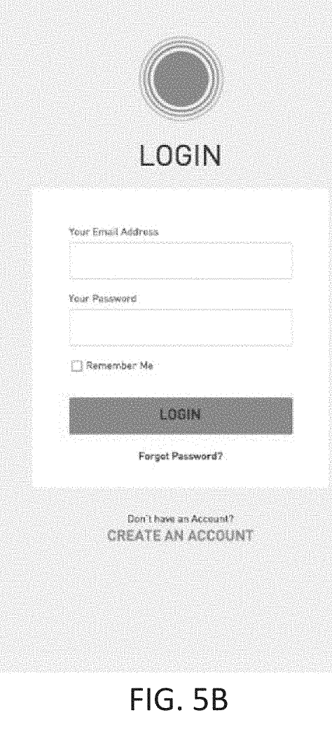

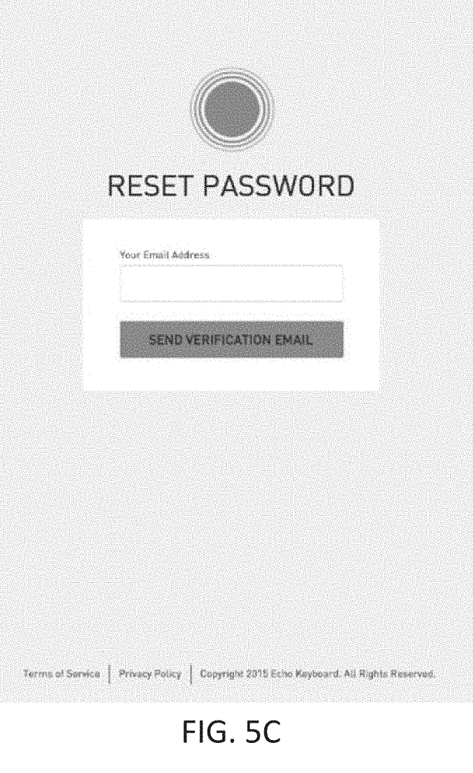

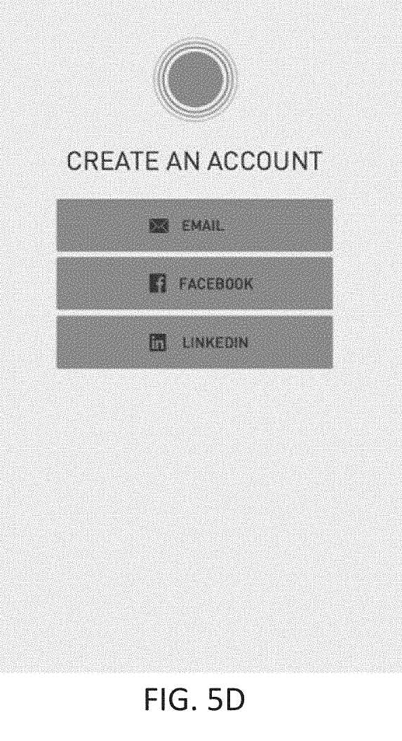

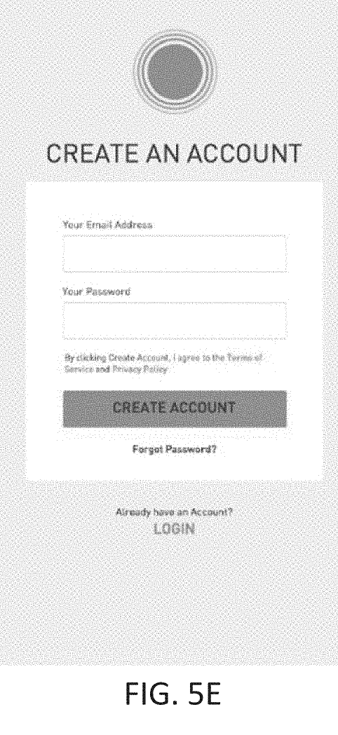

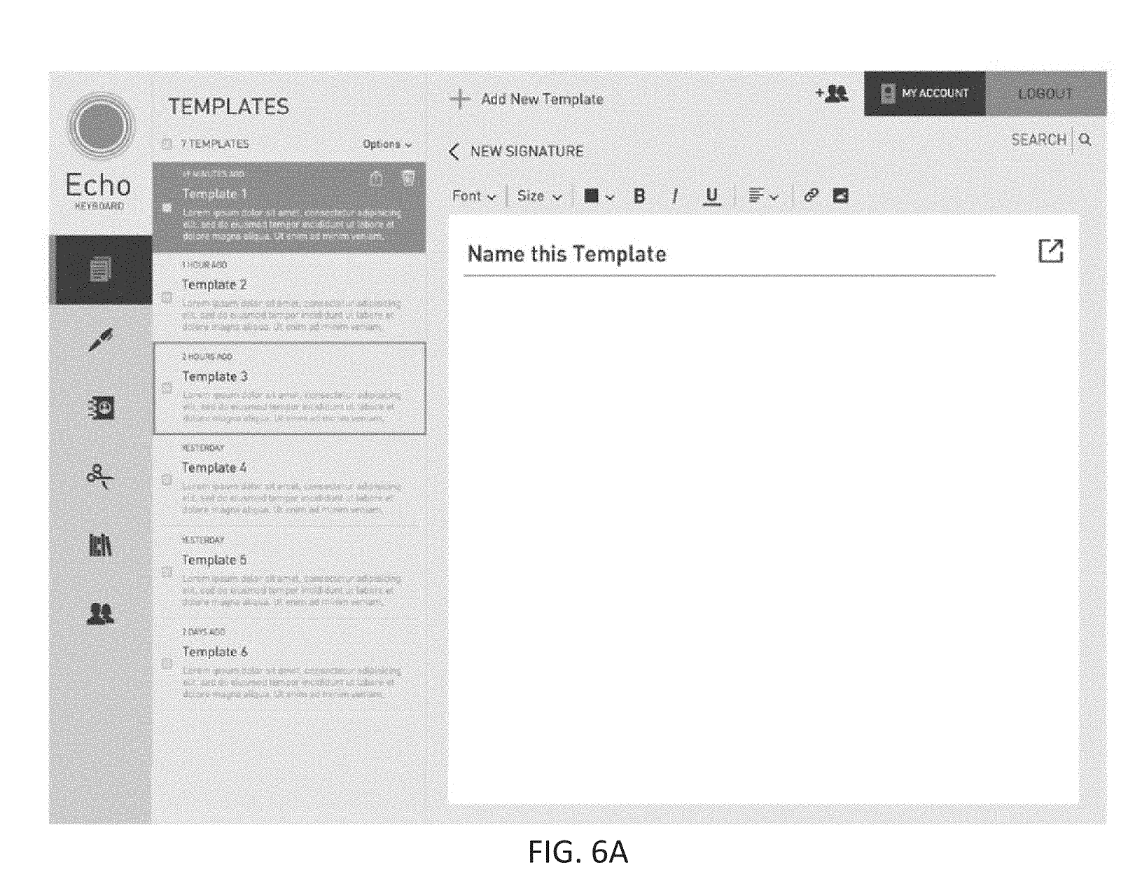

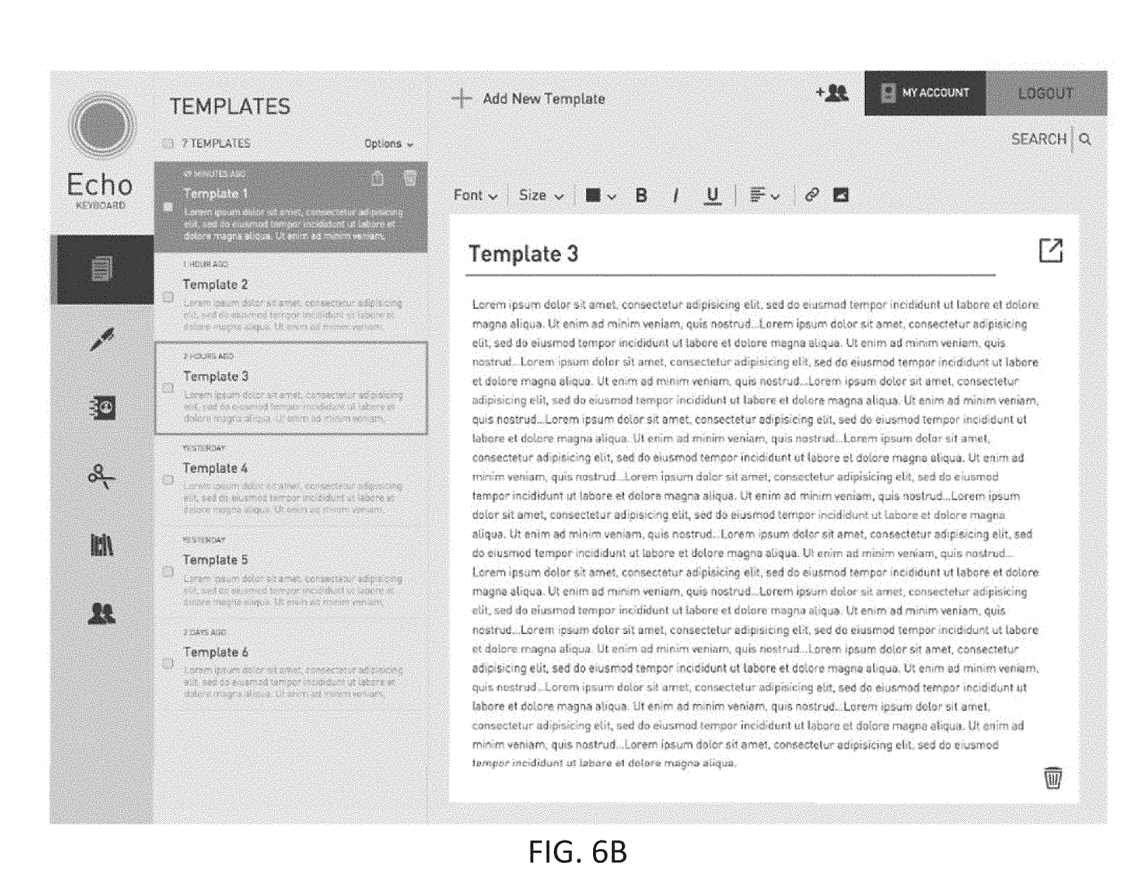

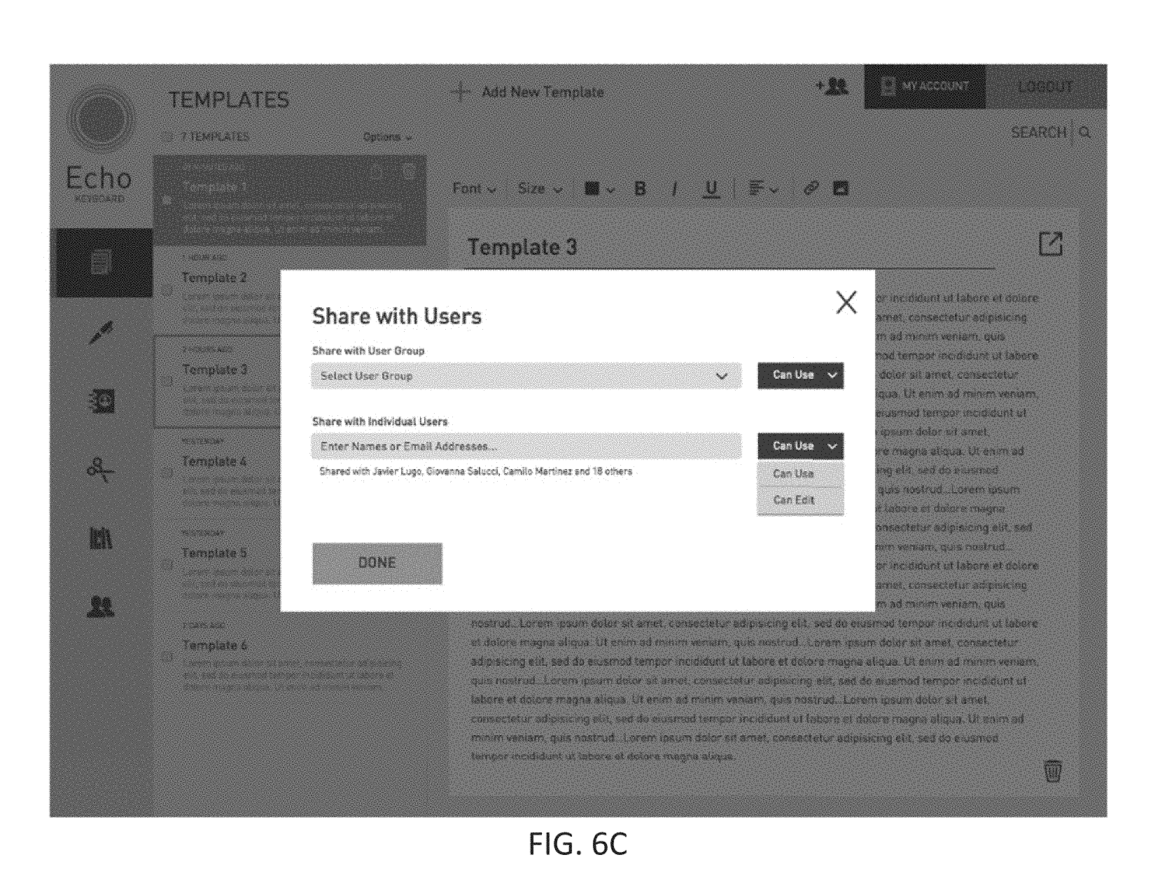

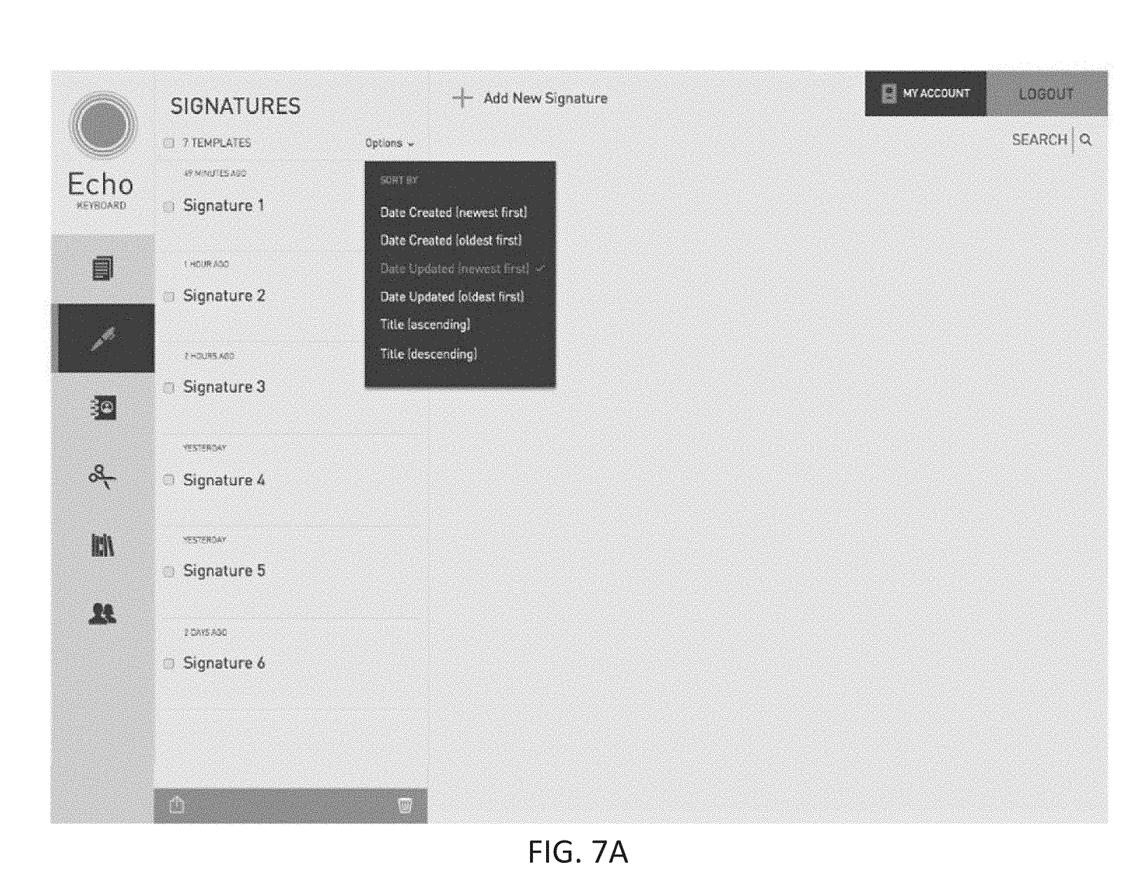

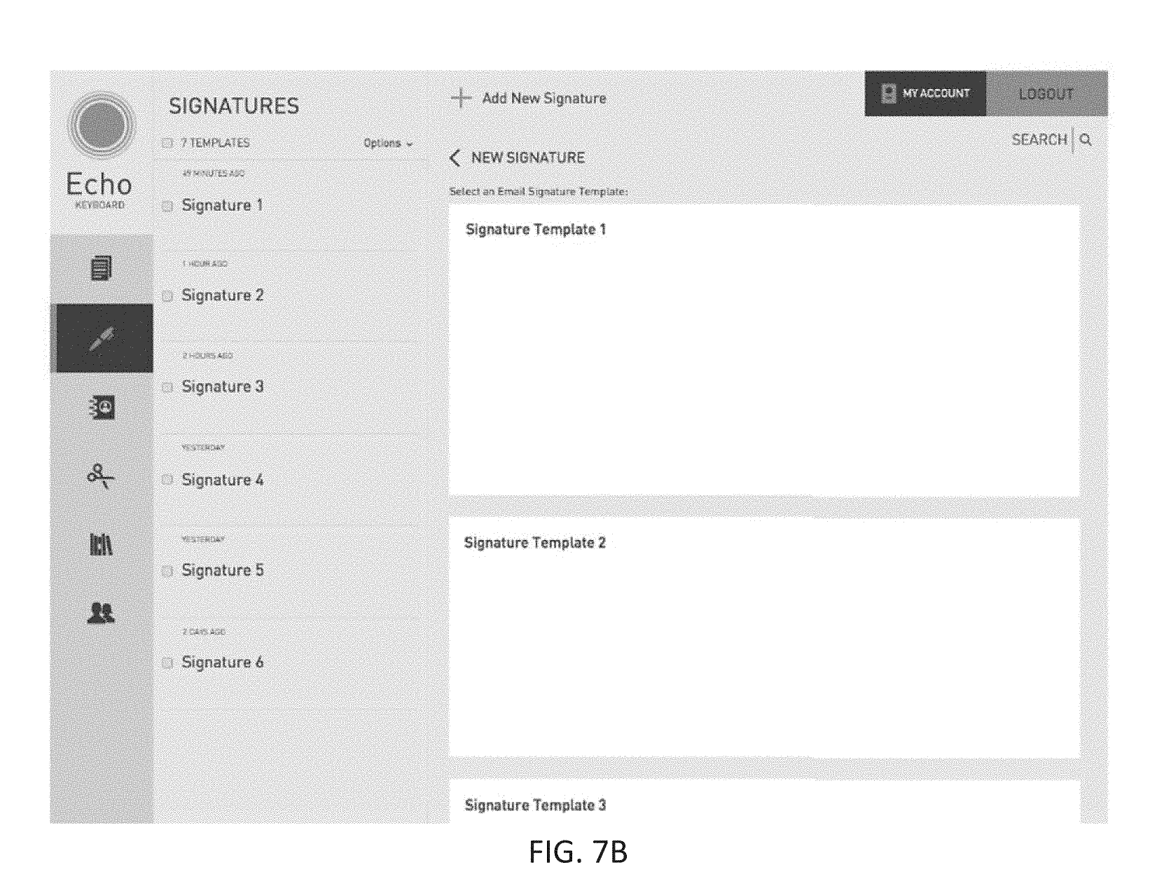

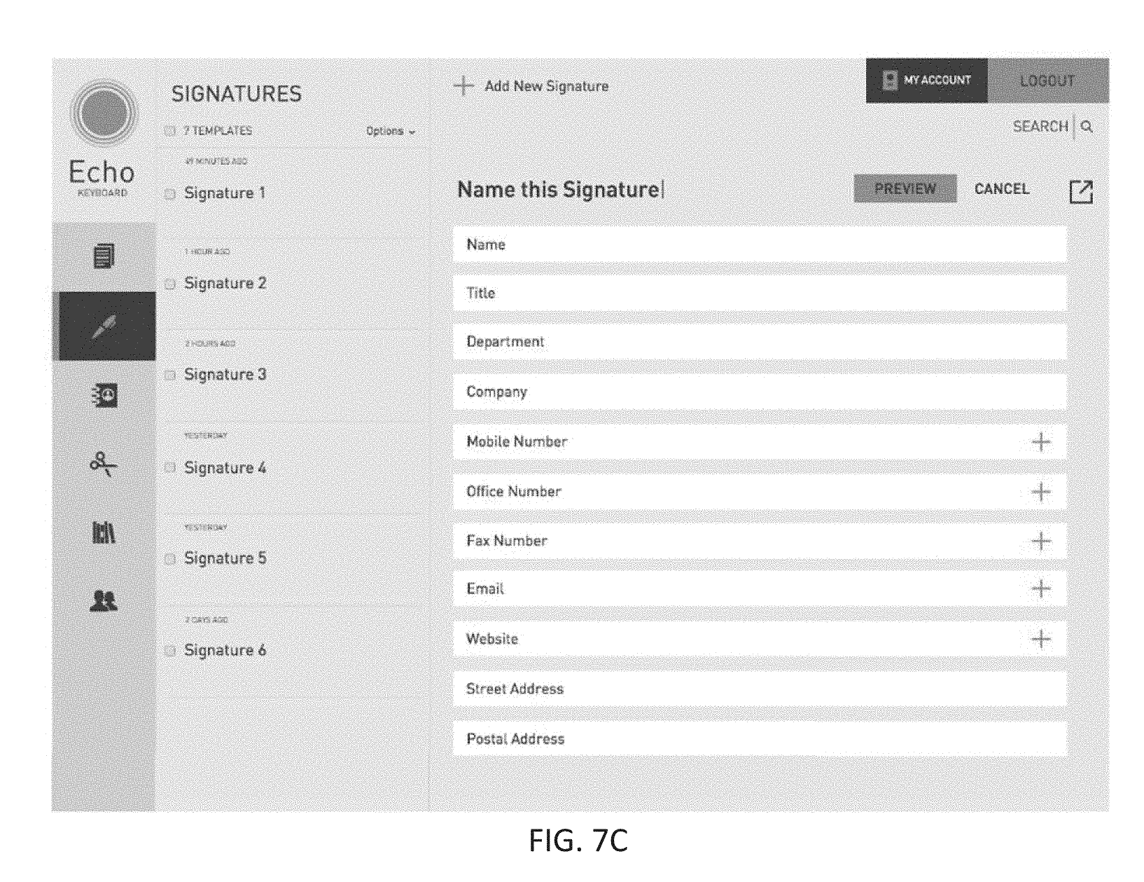

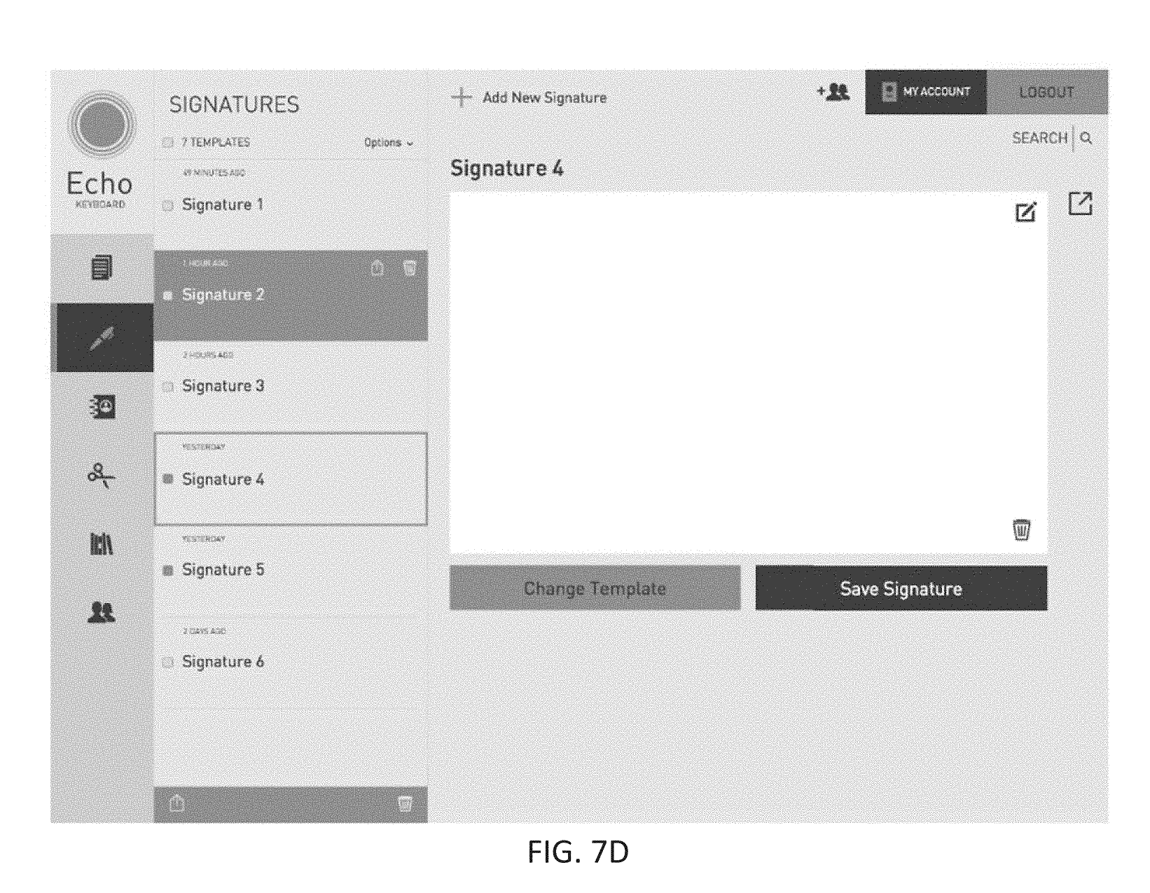

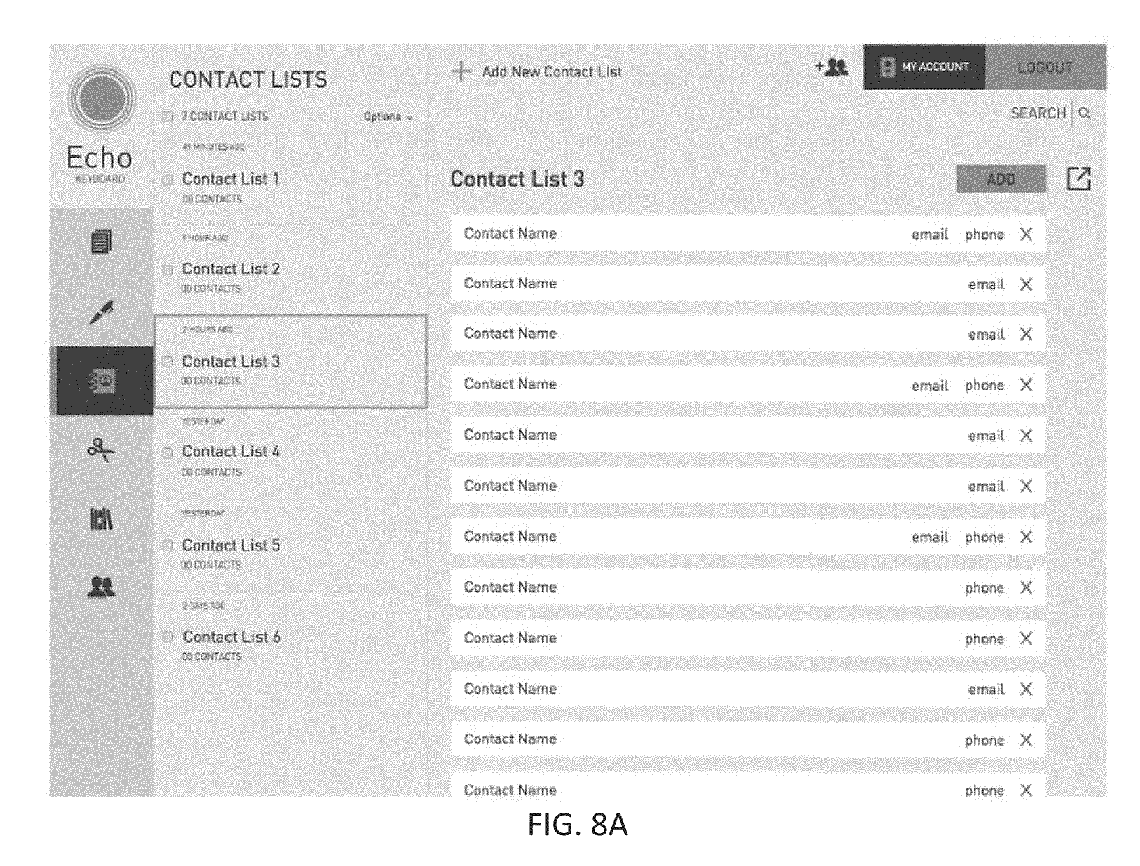

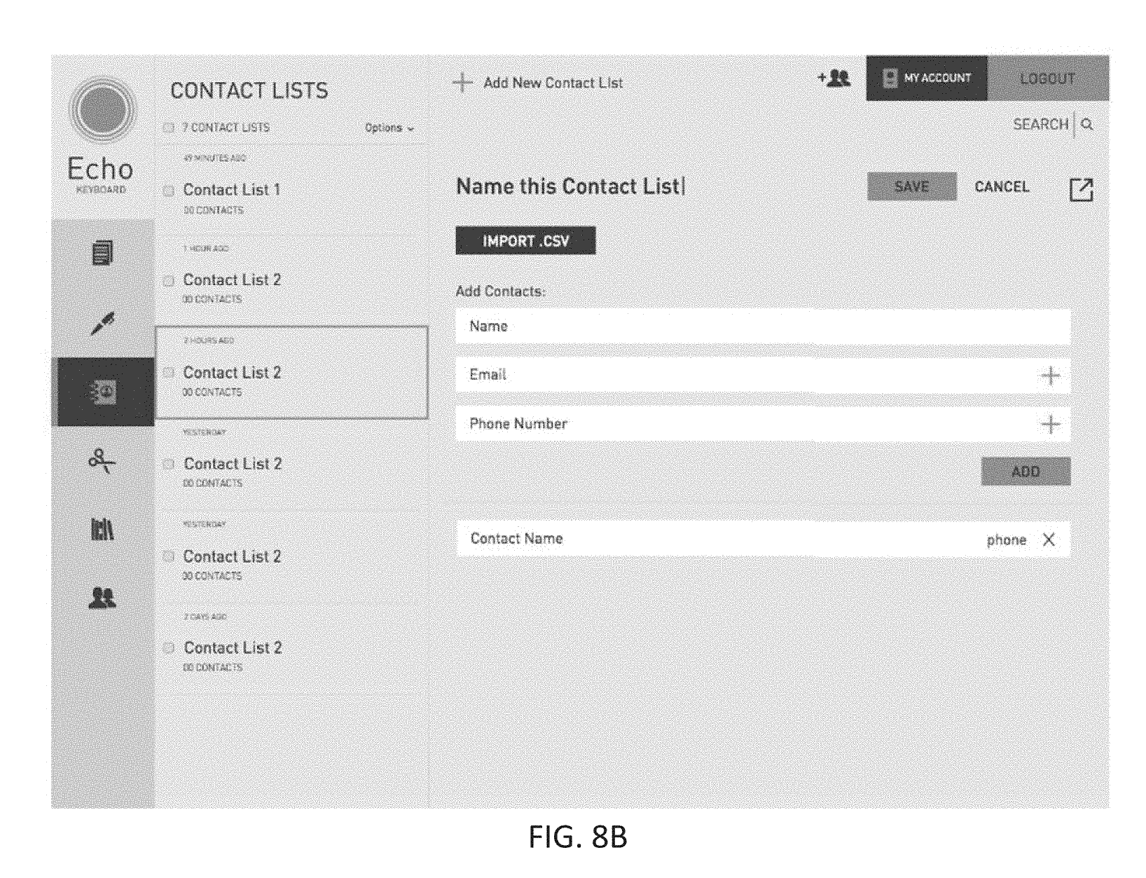

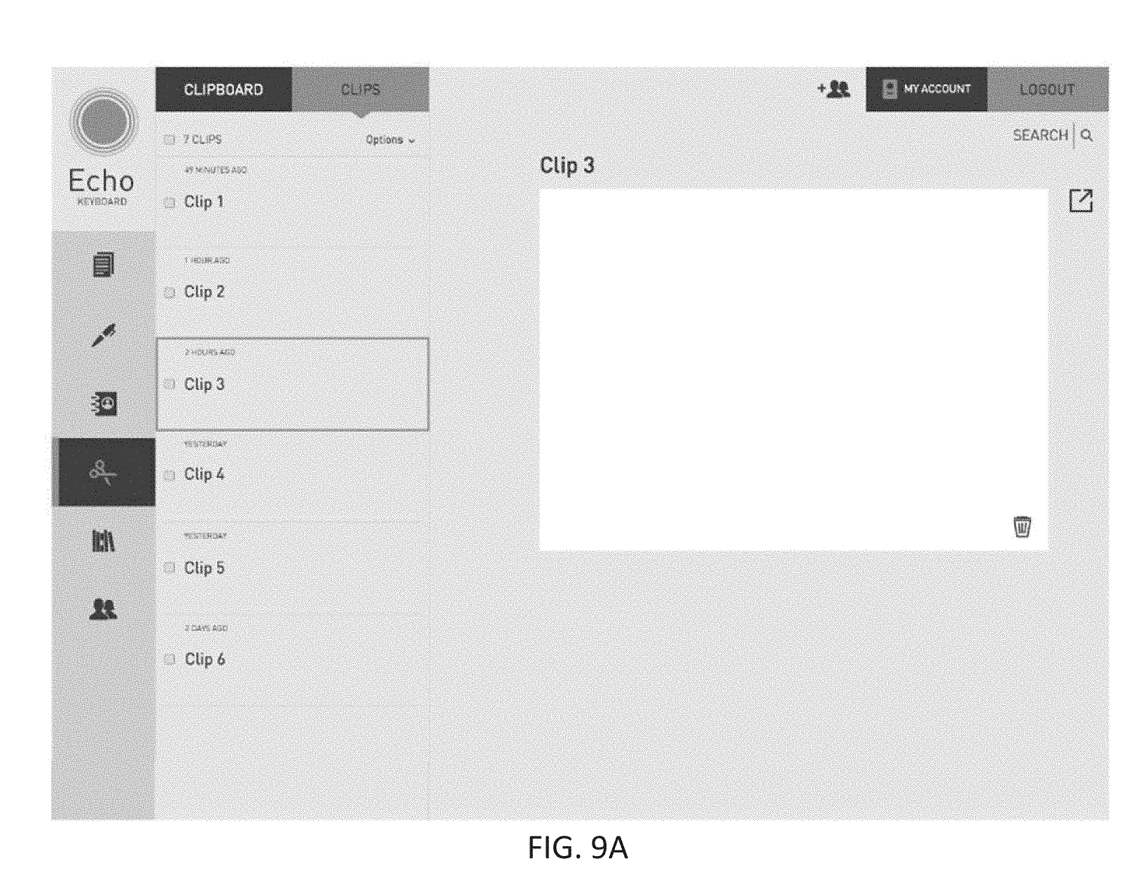

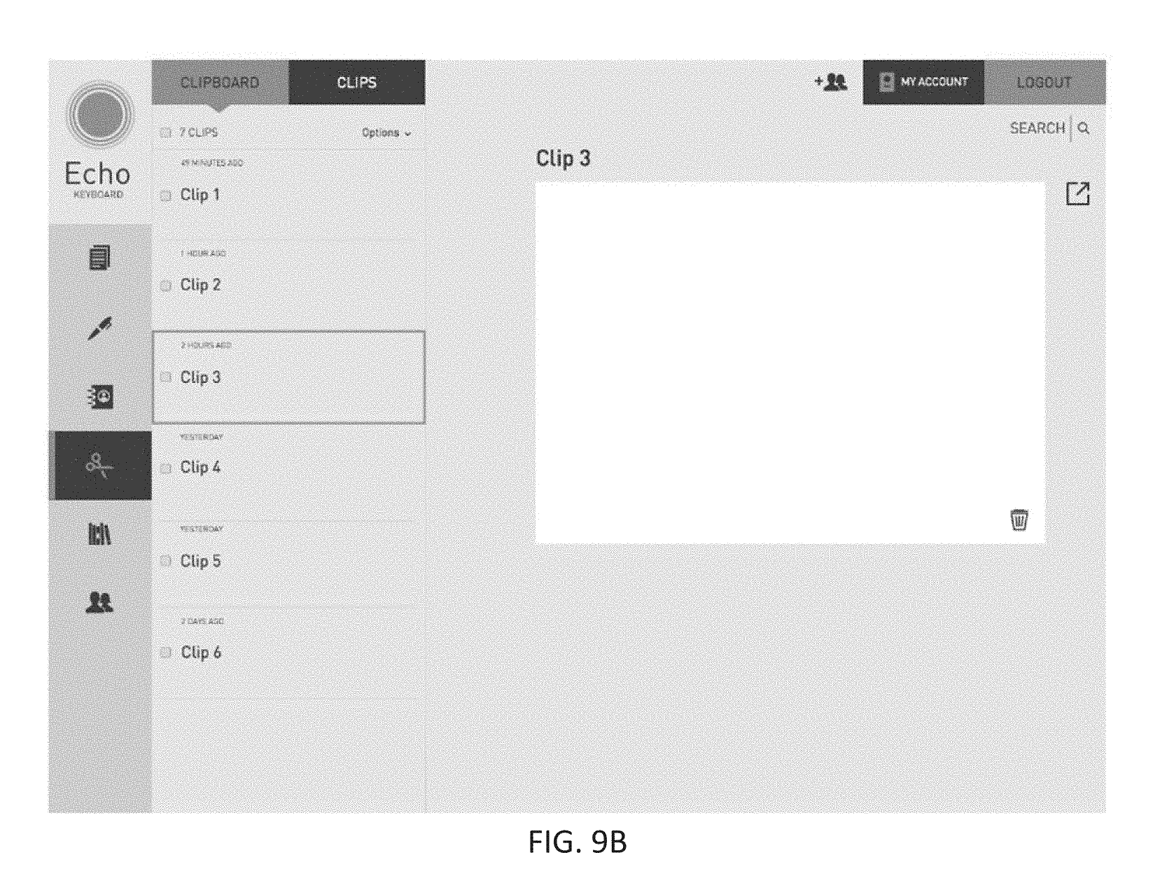

FIGS. 5A-15 are screenshots illustrating a web interface through which users may create content for sharing and distribution via the soft keyboard according to an embodiment of the invention. FIGS. 5A-5E show login and account creation screens. FIGS. 6A-6C show template creation screens. A template may be created (FIG. 6A), populated (FIG. 6B), and shared (FIG. 6C). Sharing the template may cause it to be uploaded to the cloud server and subsequently pushed to or pulled by devices associated with the user account. FIGS. 7A-7D show signature creation screens, FIGS. 8A-8B show contact list creation screens, and FIGS. 9A-9B show clip creation screens. As with template creation, these other items may be created and shared so that they may be downloaded and used on various client devices 130.

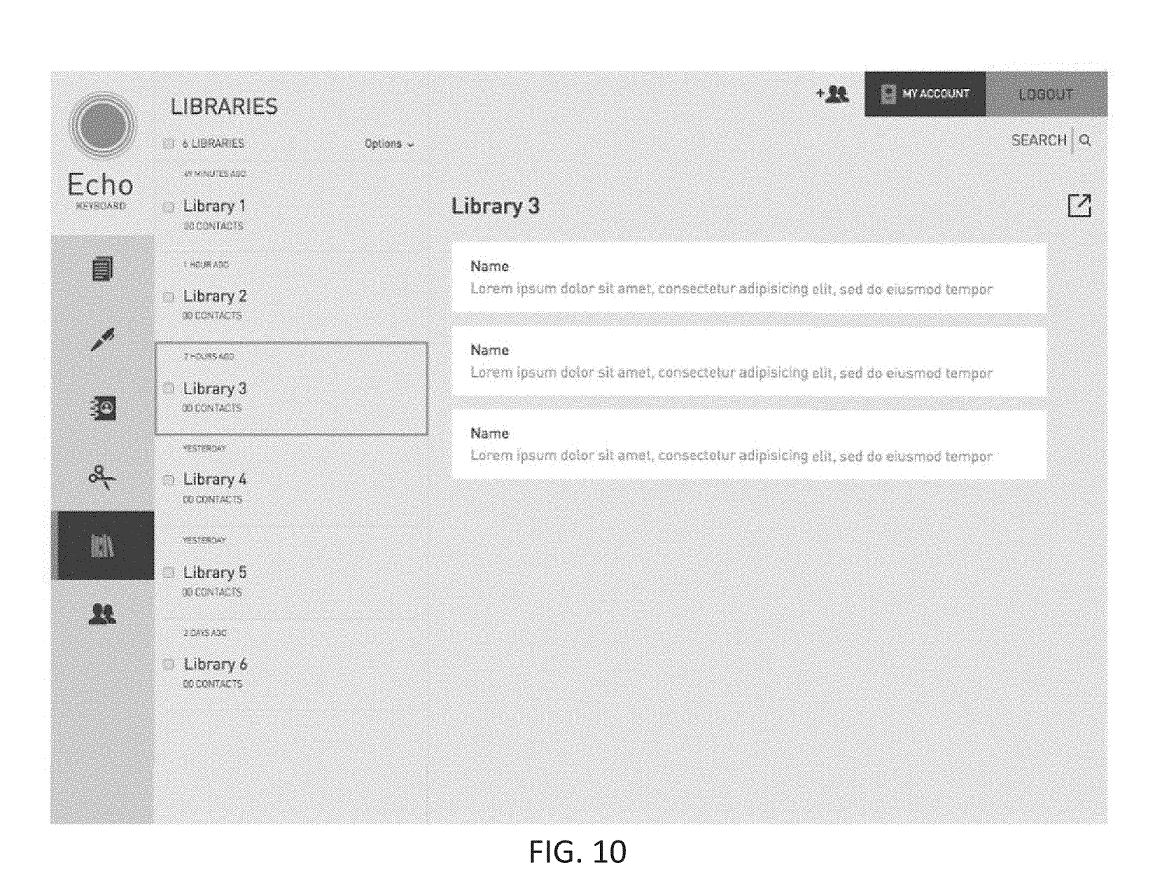

FIG. 10 depicts a libraries feature (e.g., a 3rd party marketplace). Here the user may be able to subscribe to content and obtain additional features for the interface. For example, a user may sign up for a “jokes” subscription that may push a daily joke to their device that they can easily distribute to others from their keyboard. Alternatively, another user could select a financial news subscription that may provide links to the latest news. Features may also be selected from the libraries marketplace providing additional functionality for the interface. For example, a realtor could add access to the MLS from their keyboard to be able to distribute all the current listings.

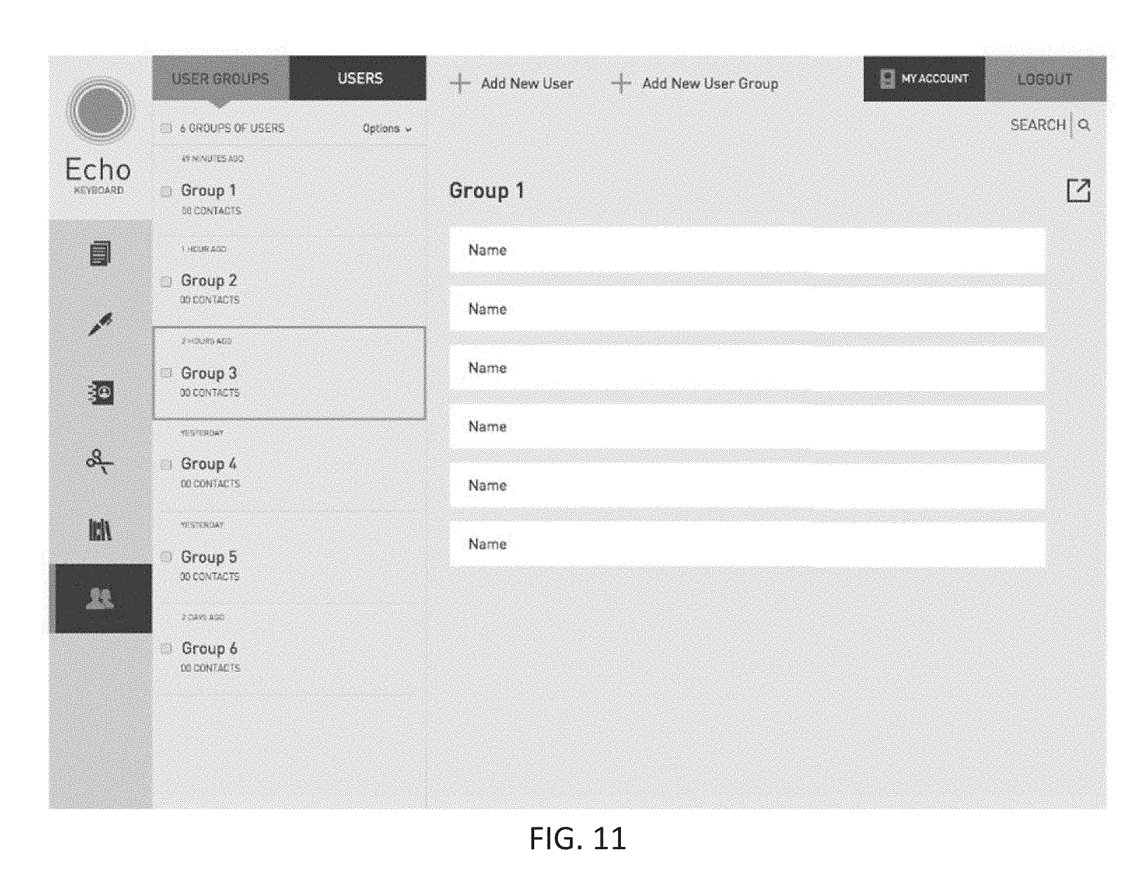

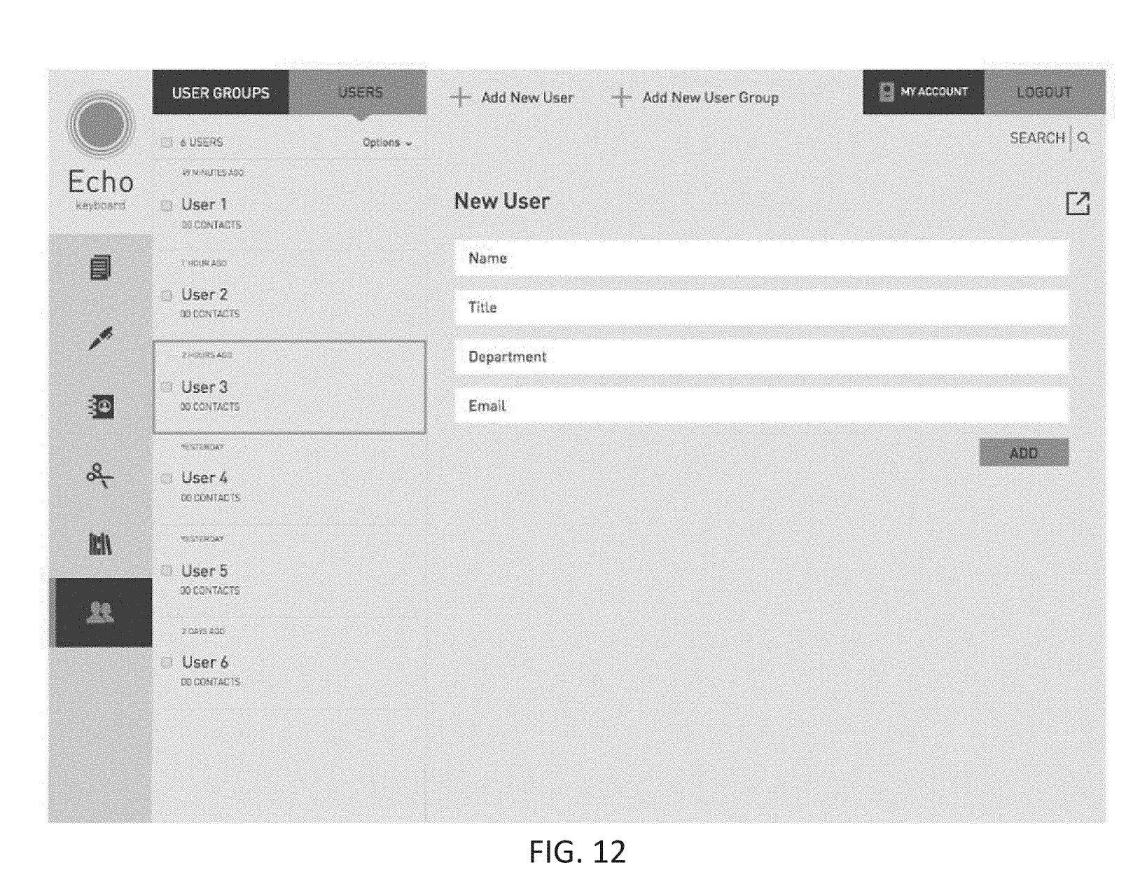

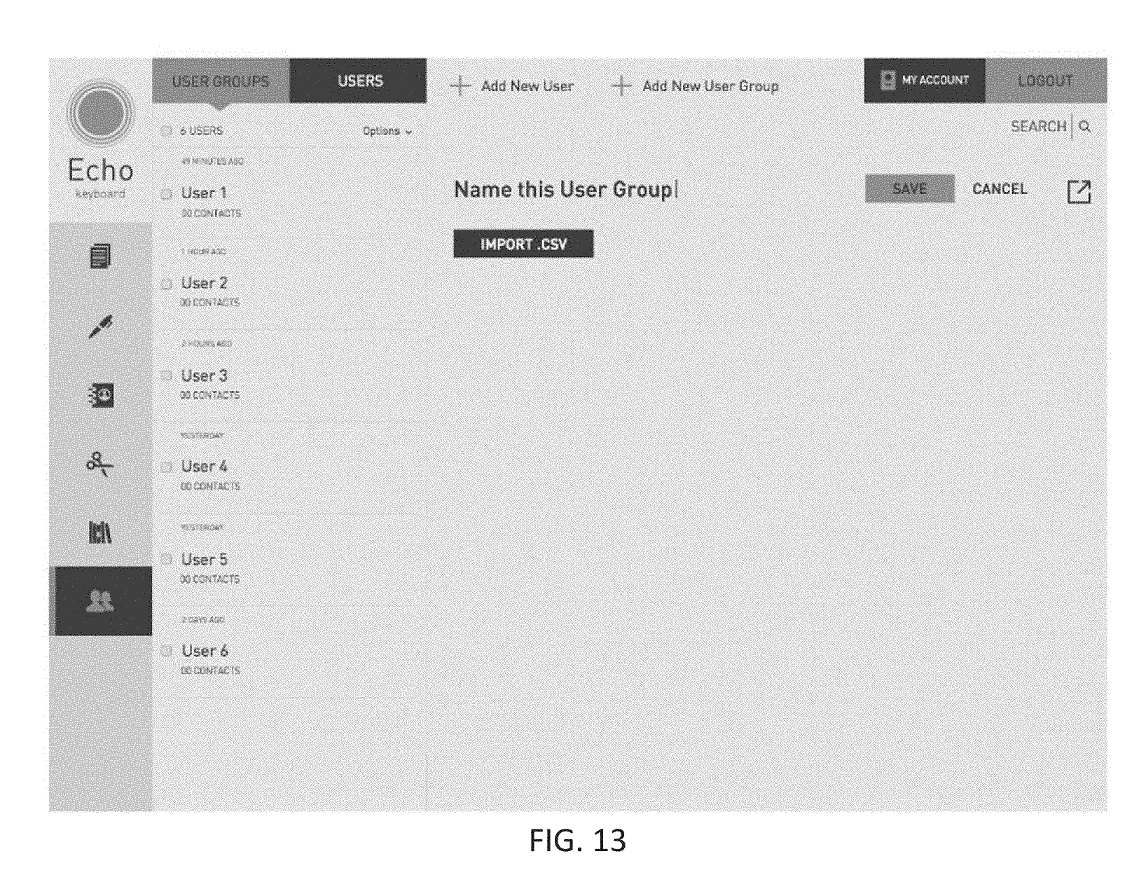

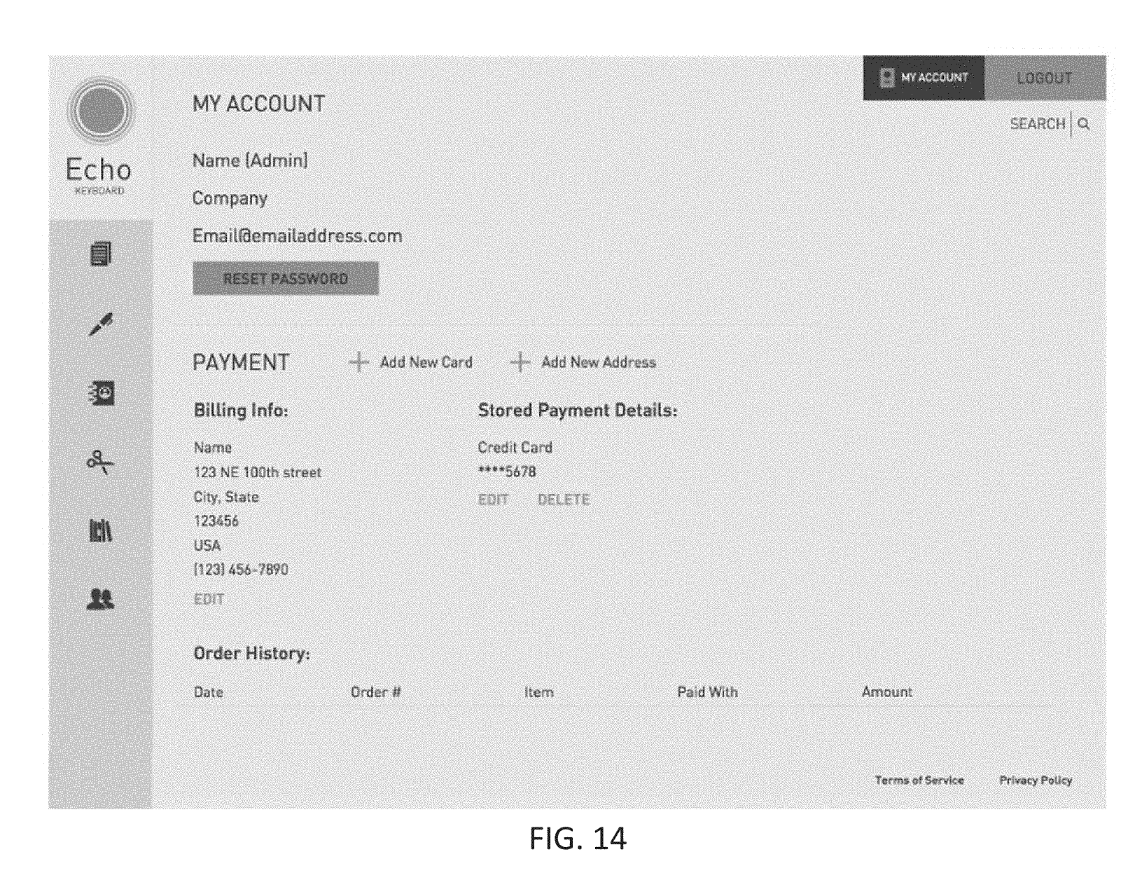

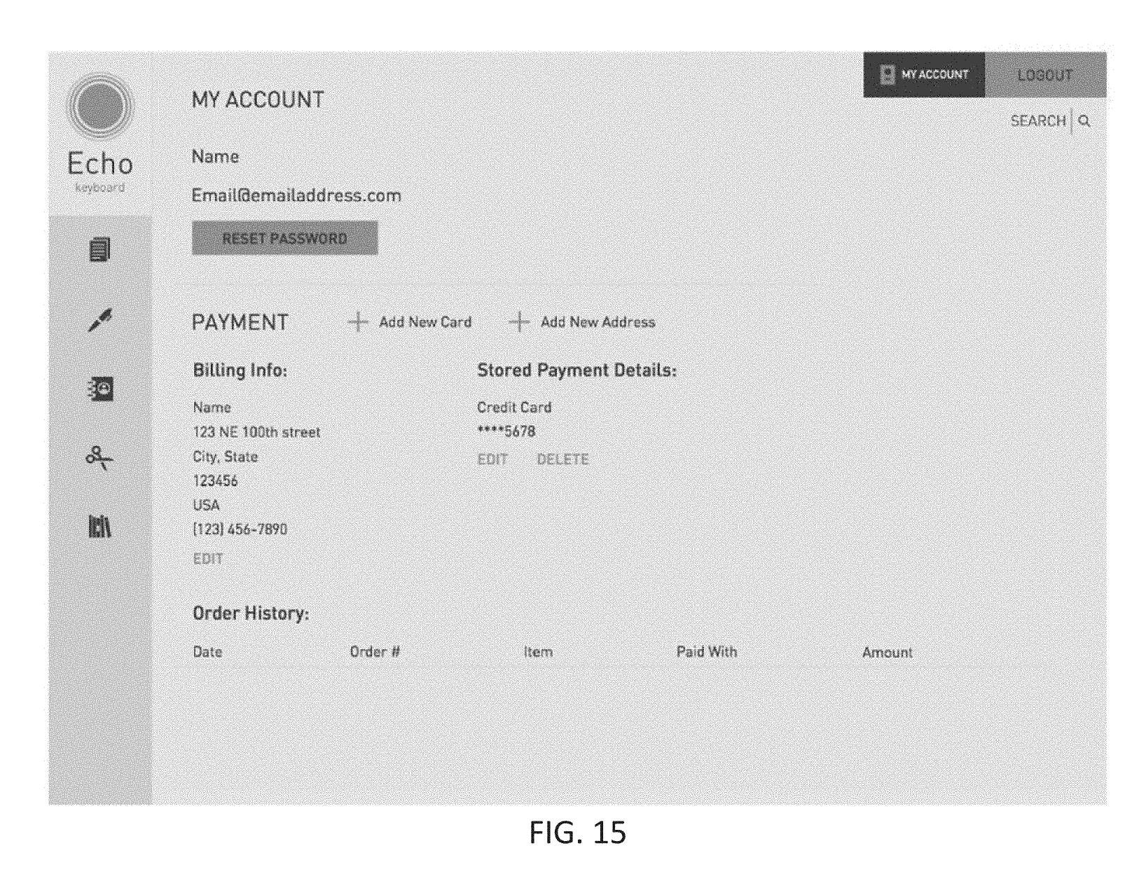

FIG. 11 depicts an interface where an administrator can create groups of users to which to distribute content. For example, a sales manager in a company could create a group for each geographical sales region and push the monthly sales to the sales personnel including region-specific data. FIG. 12 depicts an interface where an administrator can create users which can then be added to groups (see above). FIG. 13 depicts an interface where an administrator can import a list of users (e.g., via a comma separated values file of users). FIG. 14 depicts an interface where an administrator can update the company's profile and payment information. FIG. 15 depicts an interface where a user can update their profile and payment information.

Keyboard App

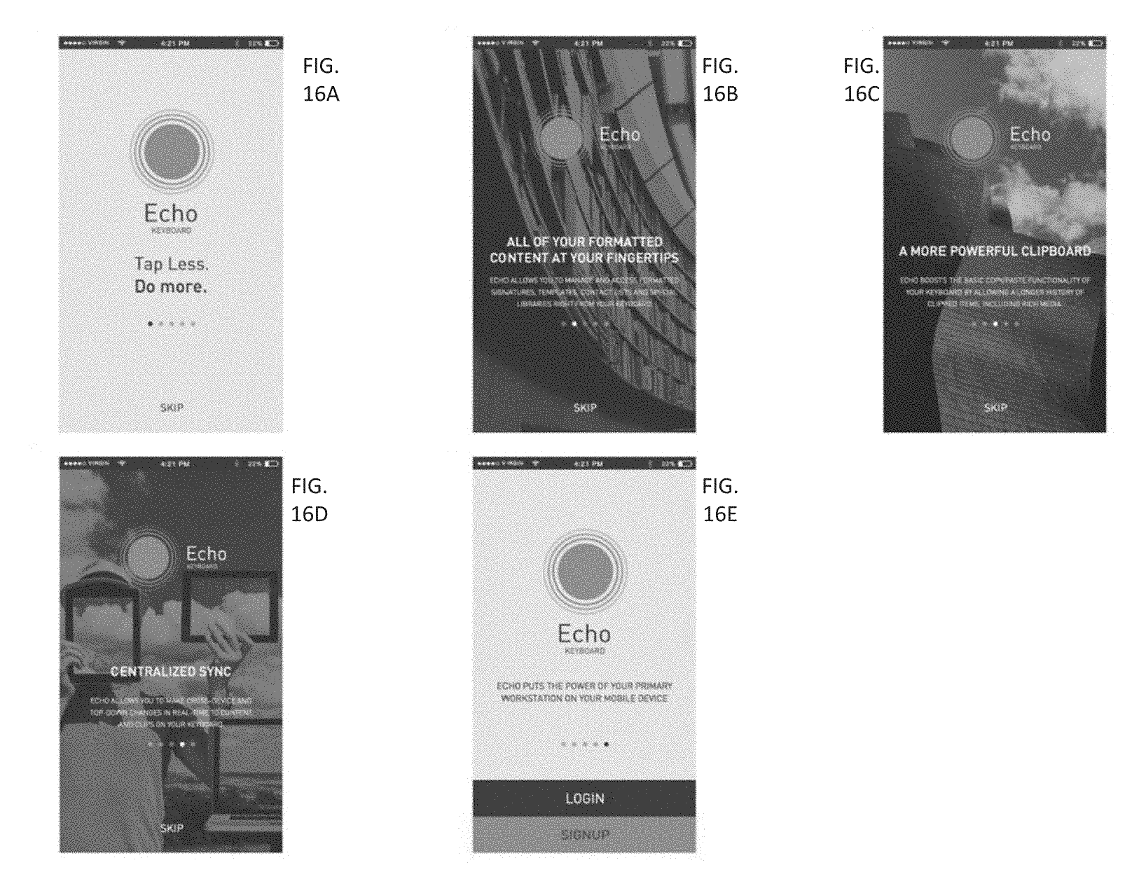

FIGS. 16A-23 are screenshots illustrating an app interface according to an embodiment of the invention. FIGS. 16A-16E show introduction screens. For example, when a user first installs the app on a device, the intro may be shown to provide information about features and functions of the soft keyboard. FIGS. 17A-17D show account creation and login screens. FIG. 18 shows a main menu, which may allow a user to access different types of content that may be shared using the keyboard. FIGS. 19A-19C are template creation screens, FIGS. 20A-20E are signature creation screens, FIGS. 21A-21C are contact list creation screens, and FIGS. 22A-22E are clip creation screens. As with the web interface, a user may create, edit, and share items using these screens. Once created, an item may appear both in the keyboard on the mobile device on which the app is running and in the keyboard of any other device associated with the user account. FIG. 23 is an account settings screen, through which a user may edit their email and password settings, view information about the keyboard, logout, and/or cancel the account.

Soft Keyboard

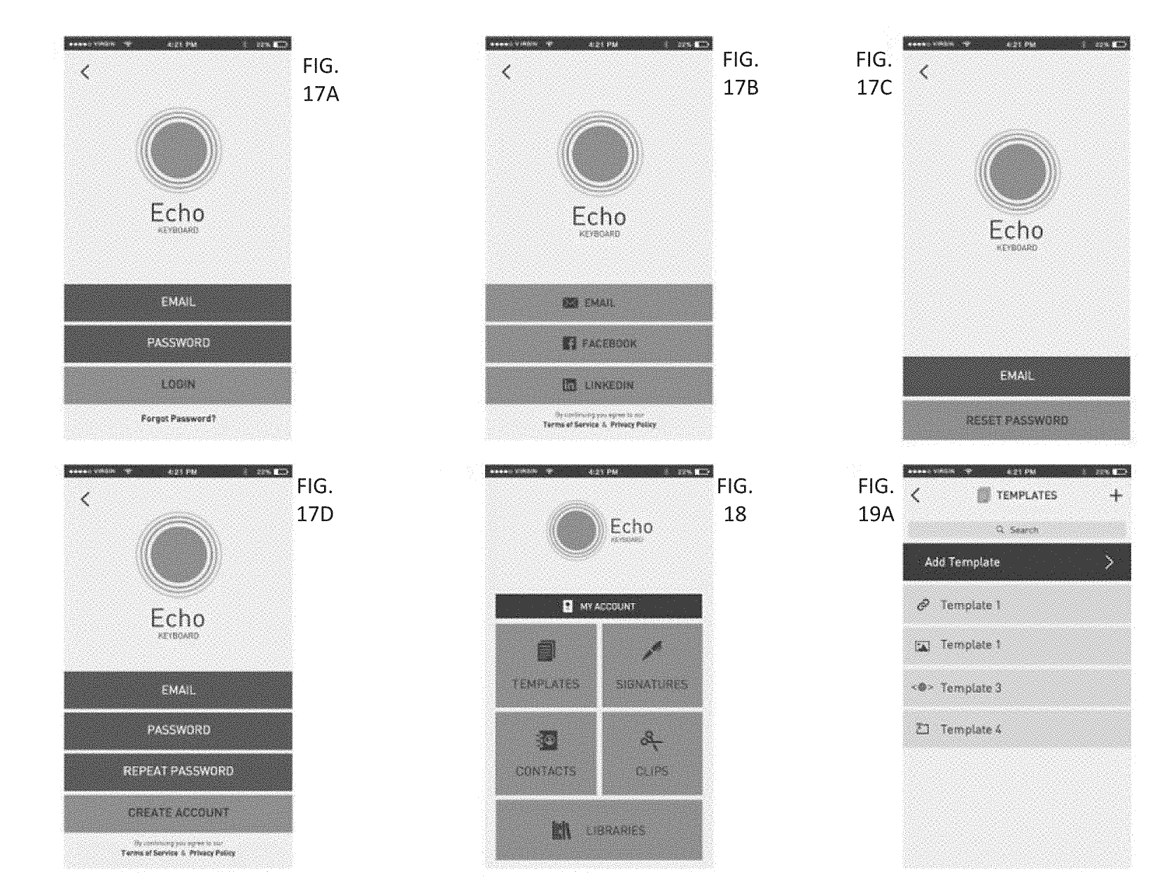

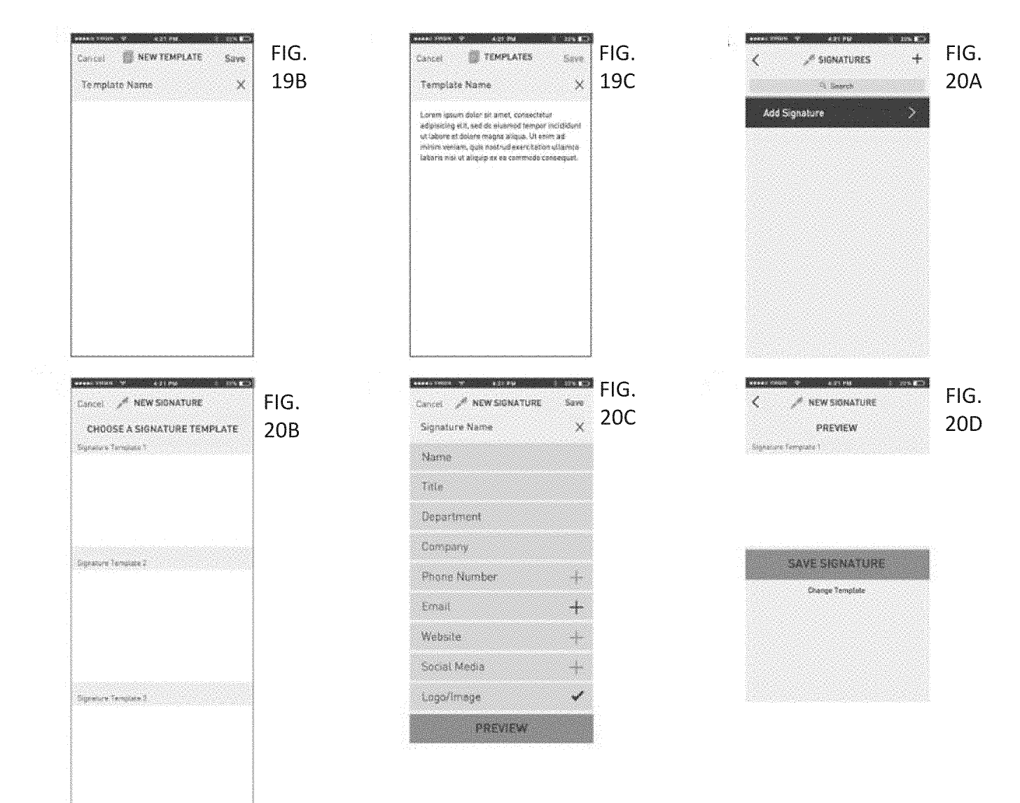

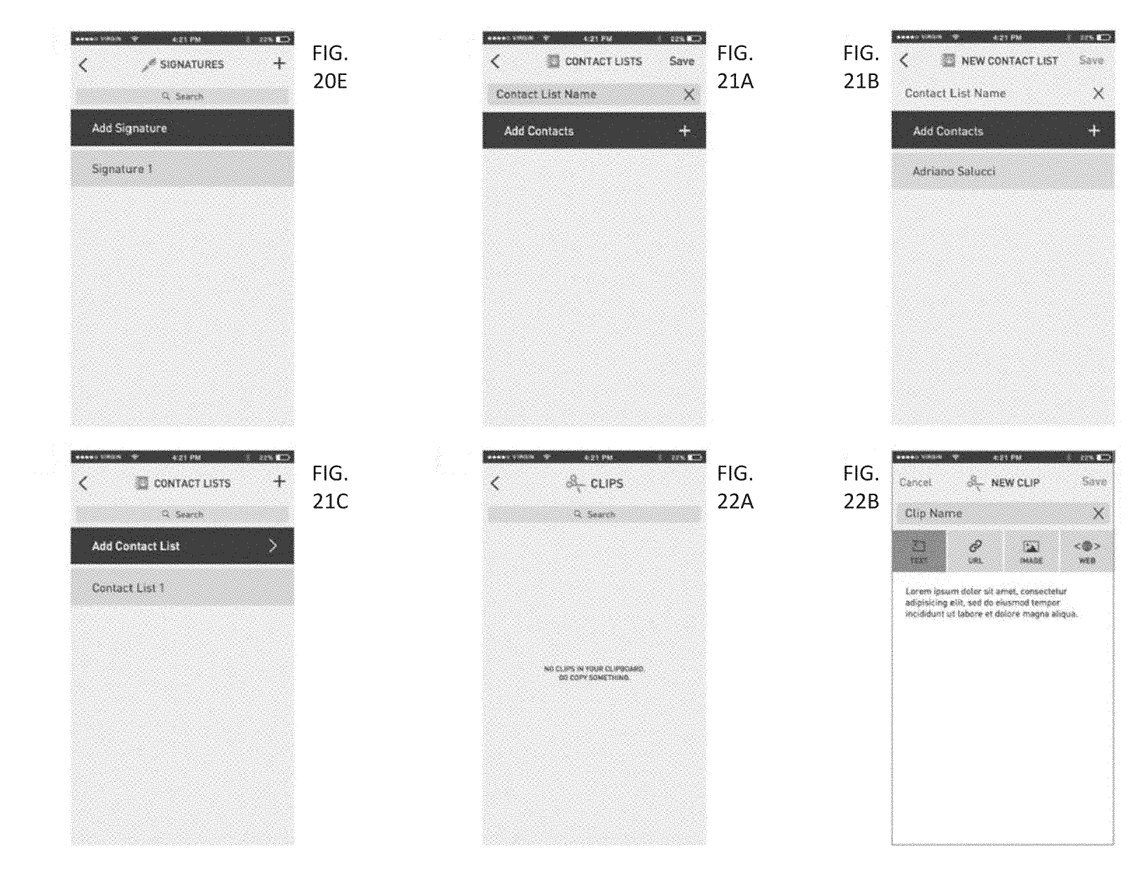

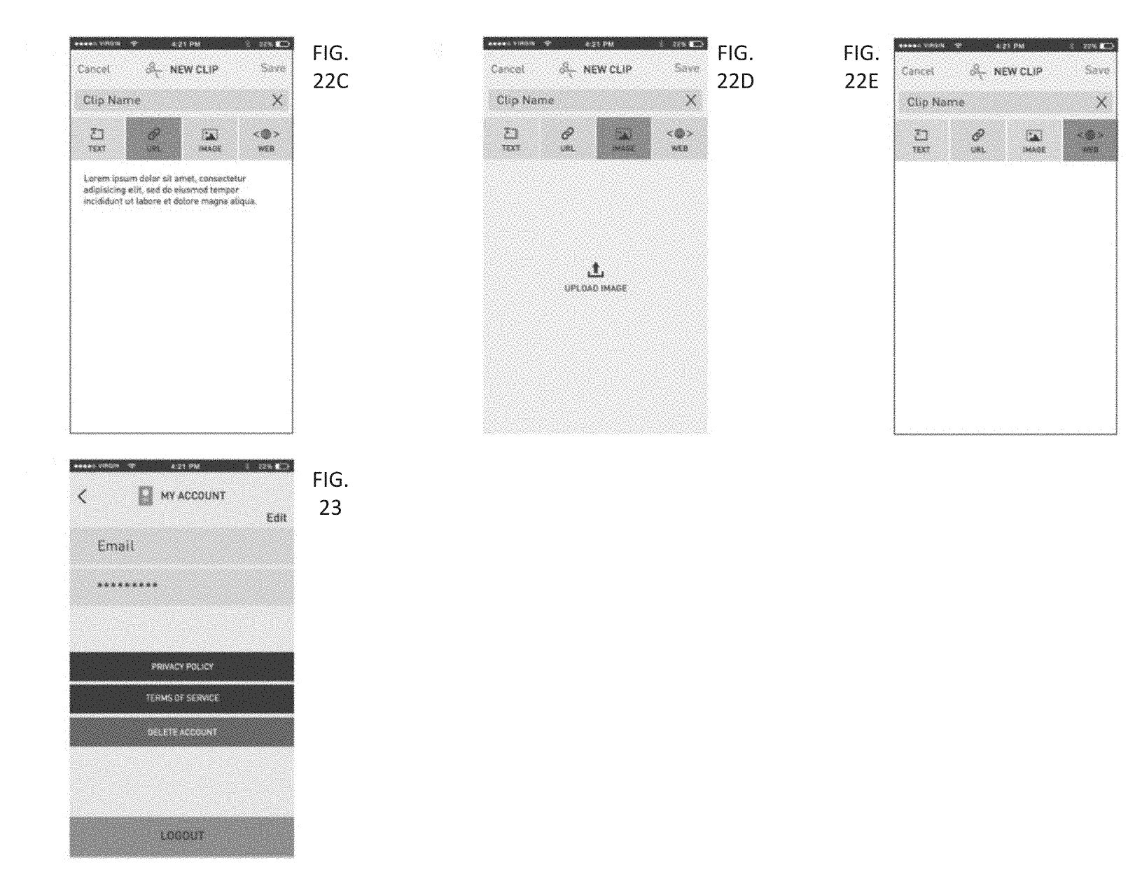

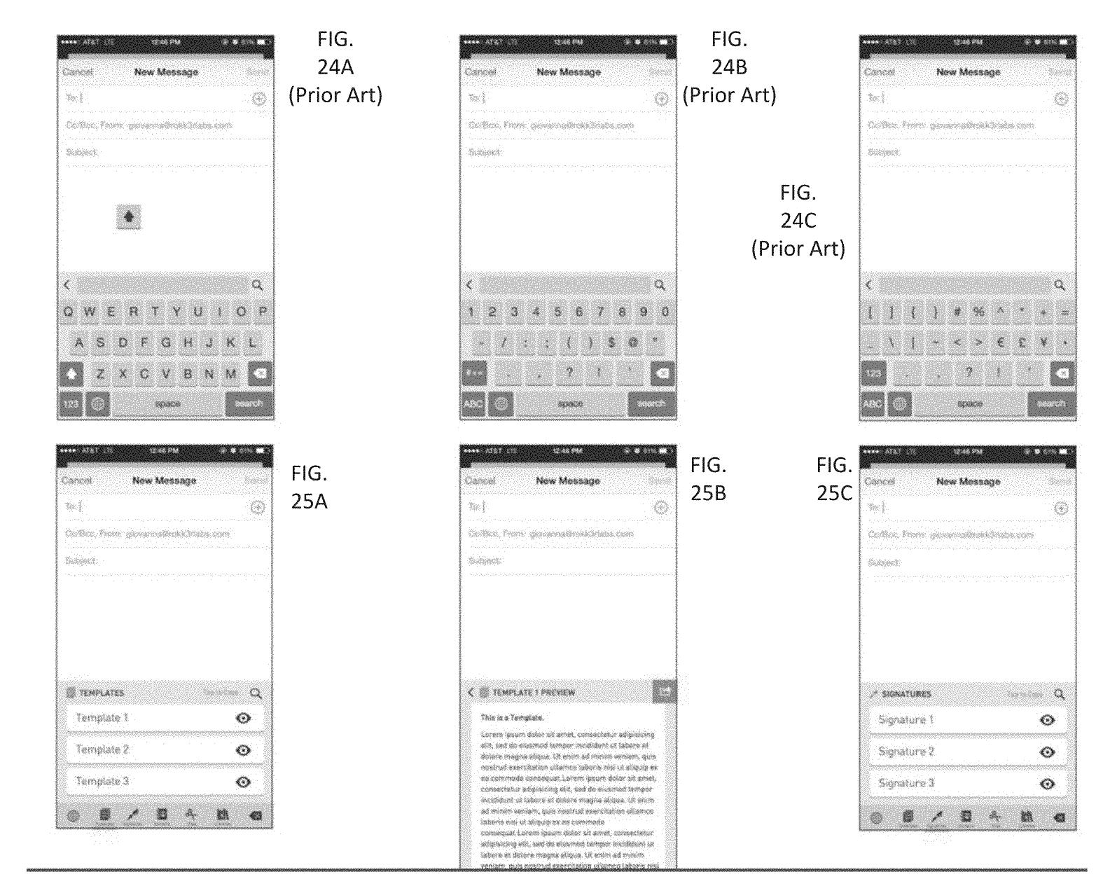

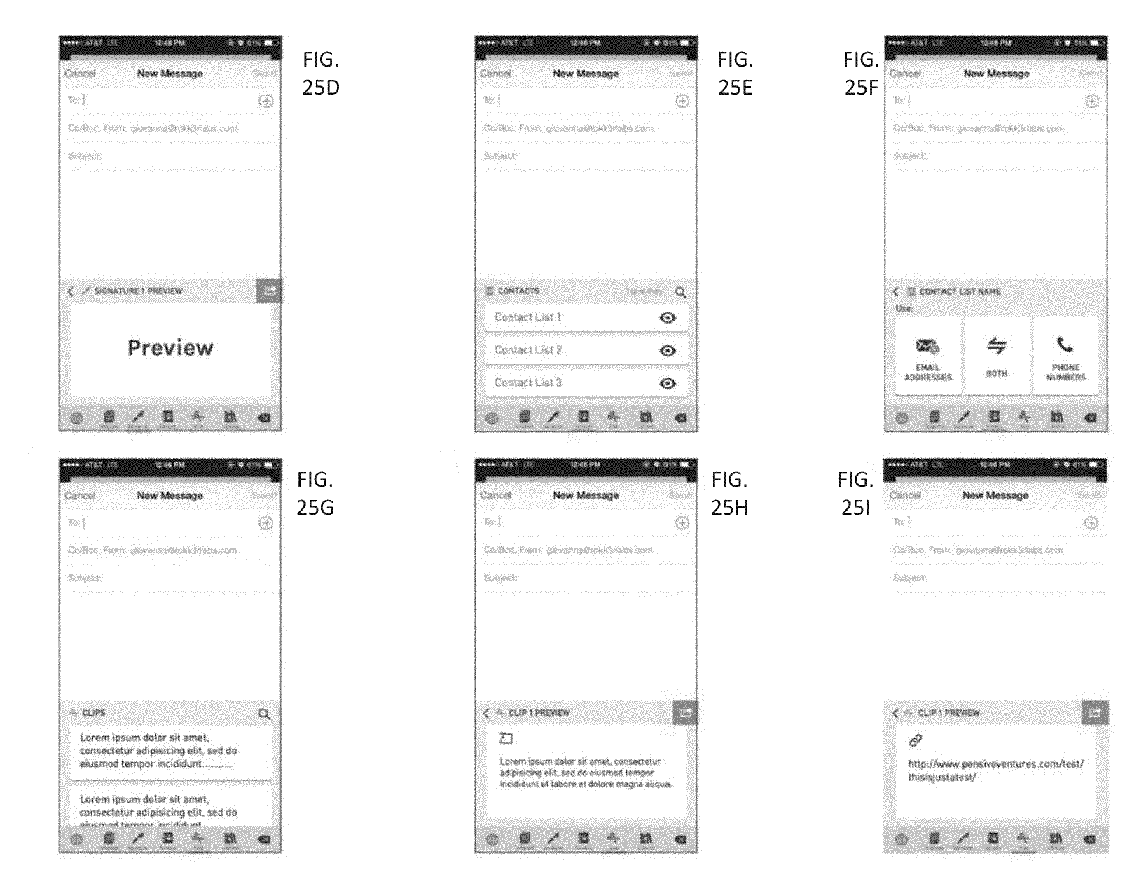

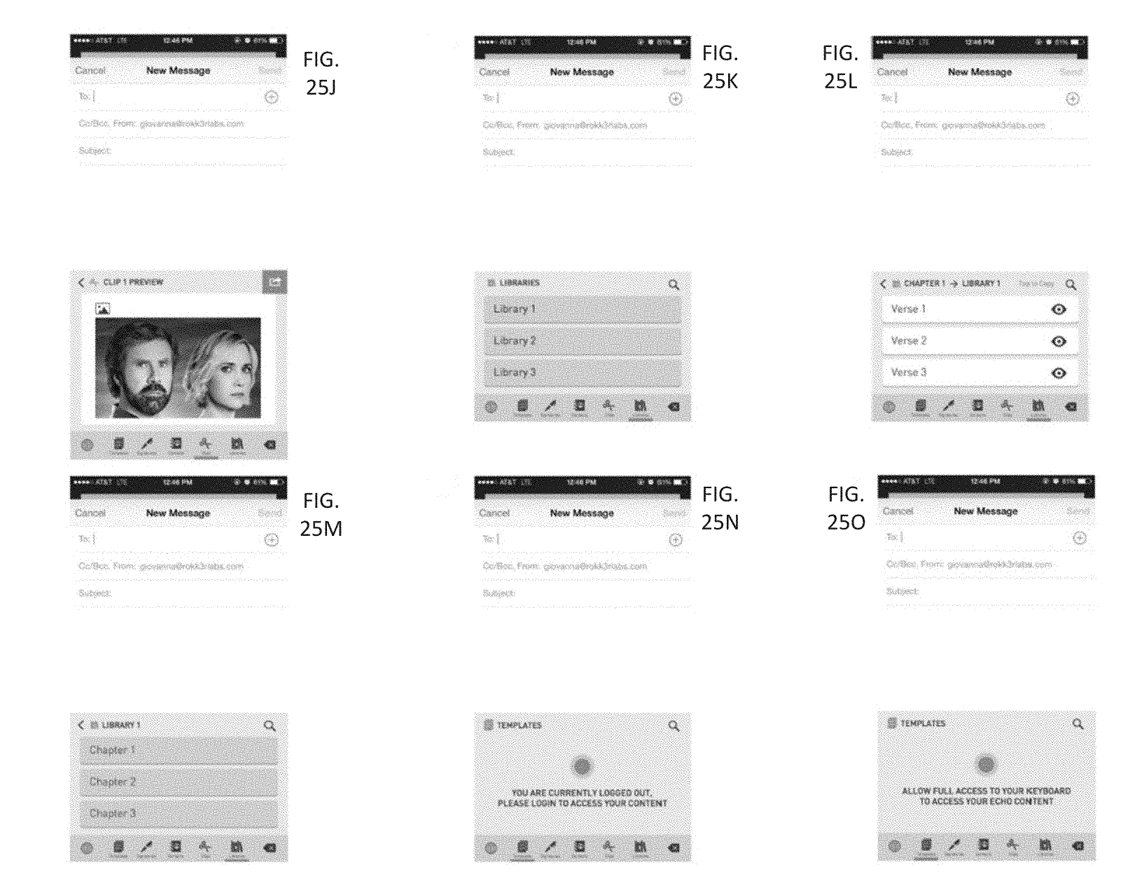

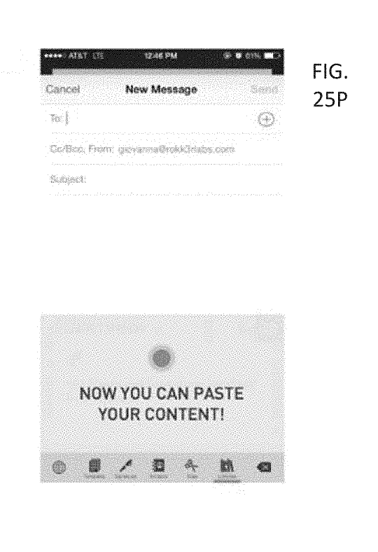

FIGS. 24A-24C are standard alphanumeric keyboard screenshots in a message composition app such as an email app. FIGS. 25A-25P are screenshots of a soft keyboard in use with other applications according to an embodiment of the invention. In FIGS. 25A-25P, the keyboard has been switched from an alphanumeric keyboard interface to an interface for inserting content that has been developed as described above. The interfaces may be accessed via the icons at the bottom of the screen. For example, in FIGS. 25A-25B, a user may access saved templates and insert them into the message. A template may be useful for providing a pre-written email that may be inserted into the body of the message and edited using the alphanumeric keyboard. In FIGS. 25C-25D, a preformatted signature may be selected and inserted into the message. In FIGS. 25E-25F, saved contacts may be accessed and pasted into the “to:” line of the message. In FIGS. 25G-25J, clips may be selected and inserted into the message. Clips may include various data (e.g., text, links, videos, images, sounds, etc.). In FIGS. 25K-25M, libraries may be inserted into the message. As noted above with respect to FIGS. 5A-15, libraries may be added via a marketplace. These figures illustrate how libraries may be viewed/navigated/used via the keyboard. FIGS. 25N-25P show login interaction screens. If a user attempts to use the soft keyboard without being logged into their account, they may be prompted to do so and, when they have logged in, be notified that they may now access the saved data for insertion. As those of ordinary skill in the art will appreciate, these are examples only, and the described data insertion features may be used in any application employing a keyboard for interaction.

### Example System Architecture

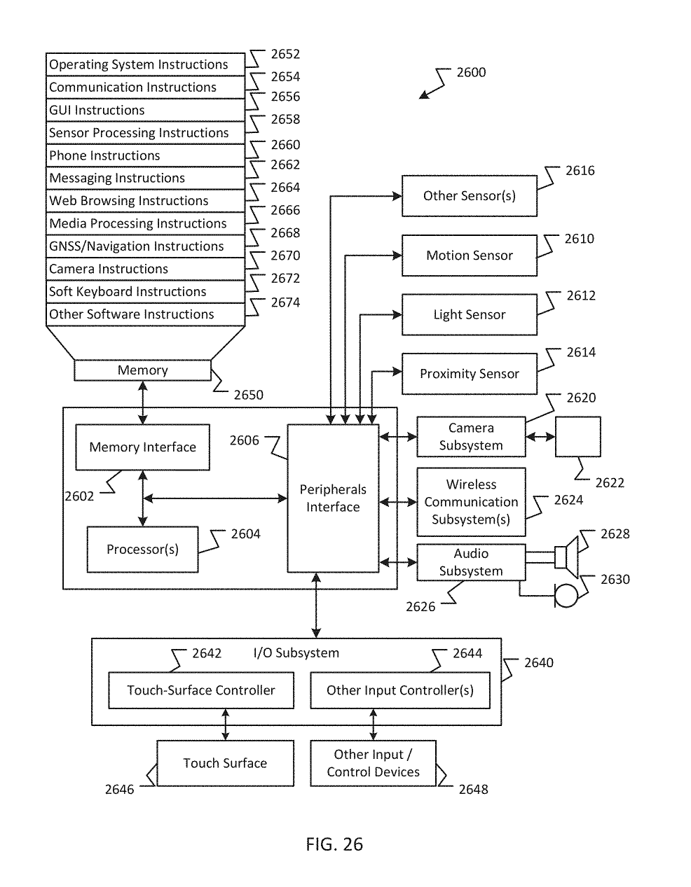

FIG. 26 is a block diagram of an example computing device 2600 that can implement the features and processes of FIGS. 1-25P. The computing device 2600 can include a memory interface 2602, one or more data processors, image processors, and/or central processing units 2604, and a peripherals interface 2606. The memory interface 2602, the one or more processors 2604, and/or the peripherals interface 2606 can be separate components or can be integrated in one or more integrated circuits. The various components in the computing device 2600 can be coupled by one or more communication buses or signal lines.

Sensors, devices, and subsystems can be coupled to the peripherals interface 2606 to facilitate multiple functionalities. For example, a motion sensor 2610, a light sensor 2612, and a proximity sensor 2614 can be coupled to the peripherals interface 2606 to facilitate orientation, lighting, and proximity functions. Other sensors 2616 can also be connected to the peripherals interface 2606, such as a global navigation satellite system (GNSS) (e.g., GPS receiver), a temperature sensor, a biometric sensor, magnetometer or other sensing device, to facilitate related functionalities.

A camera subsystem 2620 and an optical sensor 2622, e.g., a charged coupled device (CCD) or a complementary metal-oxide semiconductor (CMOS) optical sensor, can be utilized to facilitate camera functions, such as recording photographs and video clips. The camera subsystem 2620 and the optical sensor 2622 can be used to collect images of a user to be used during authentication of a user, e.g., by performing facial recognition analysis.

Communication functions can be facilitated through one or more wireless communication subsystems 2624, which can include radio frequency receivers and transmitters and/or optical (e.g., infrared) receivers and transmitters. The specific design and implementation of the communication subsystem 2624 can depend on the communication network(s) over which the computing device 2600 is intended to operate. For example, the computing device 2600 can include communication subsystems 2624 designed to operate over a GSM network, a GPRS network, an EDGE network, a Wi-Fi or WiMax network, and a Bluetooth™ network. In particular, the wireless communication subsystems 2624 can include hosting protocols such that the device 2600 can be configured as a base station for other wireless devices.

An audio subsystem 2626 can be coupled to a speaker 2628 and a microphone 2630 to facilitate voice-enabled functions, such as speaker recognition, voice replication, digital recording, and telephony functions. The audio subsystem 2626 can be configured to facilitate processing voice commands, voiceprinting and voice authentication, for example.

The I/O subsystem 2640 can include a touch-surface controller 2642 and/or other input controller(s) 2644. The touch-surface controller 2642 can be coupled to a touch surface 2646. The touch surface 2646 and touch-surface controller 2642 can, for example, detect contact and movement or break thereof using any of a plurality of touch sensitivity technologies, including but not limited to capacitive, resistive, infrared, and surface acoustic wave technologies, as well as other proximity sensor arrays or other elements for determining one or more points of contact with the touch surface 2646.

The other input controller(s) 2644 can be coupled to other input/control devices 2648, such as one or more buttons, rocker switches, thumb-wheel, infrared port, USB port, and/or a pointer device such as a stylus. The one or more buttons (not shown) can include an up/down button for volume control of the speaker 2628 and/or the microphone 2630.

In some implementations, a pressing of the button for a first duration can disengage a lock of the touch surface 2646; and a pressing of the button for a second duration that is longer than the first duration can turn power to the computing device 2600 on or off. Pressing the button for a third duration can activate a voice control, or voice command, module that enables the user to speak commands into the microphone 2630 to cause the device to execute the spoken command. The user can customize a functionality of one or more of the buttons. The touch surface 2646 can, for example, also be used to implement virtual or soft buttons and/or a keyboard.

In some implementations, the computing device 2600 can present recorded audio and/or video files, such as MP3, AAC, and MPEG files. In some implementations, the computing device 2600 can include the functionality of an MP3 player, such as an iPod™. The computing device 2600 can, therefore, include a 36-pin connector that is compatible with the iPod. Other input/output and control devices can also be used.

The memory interface 2602 can be coupled to memory 2650. The memory 2650 can include high-speed random access memory and/or non-volatile memory, such as one or more magnetic disk storage devices, one or more optical storage devices, and/or flash memory (e.g., NAND, NOR). The memory 2650 can store an operating system 2652, such as Darwin, RTXC, LINUX, UNIX, OS X, WINDOWS, or an embedded operating system such as VxWorks.

The operating system 2652 can include instructions for handling basic system services and for performing hardware dependent tasks. In some implementations, the operating system 2652 can be a kernel (e.g., UNIX kernel). In some implementations, the operating system 2652 can include instructions for performing voice authentication. For example, operating system 2652 can implement some or all of the self-review features as described with reference to FIGS. 1-25P, alone or in combination with other instructions.

The memory 2650 can also store communication instructions 2654 to facilitate communicating with one or more additional devices, one or more computers and/or one or more servers. The memory 2650 can include graphical user interface instructions 2656 to facilitate graphic user interface processing; sensor processing instructions 2658 to facilitate sensor-related processing and functions; phone instructions 2660 to facilitate phone-related processes and functions; electronic messaging instructions 2662 to facilitate electronic-messaging related processes and functions; web browsing instructions 2664 to facilitate web browsing-related processes and functions; media processing instructions 2666 to facilitate media processing-related processes and functions; GNSS/Navigation instructions 2668 to facilitate GNSS and navigation-related processes and instructions; and/or camera instructions 2670 to facilitate camera-related processes and functions.

The memory 2650 can store soft keyboard instructions 2672 to facilitate other processes and functions, such as the soft keyboard processes and functions as described with reference to FIGS. 1-25P. The memory 2650 can also store other software instructions 2674, such as web video instructions to facilitate web video-related processes and functions; and/or web shopping instructions to facilitate web shopping-related processes and functions. In some implementations, the media processing instructions 2666 are divided into audio processing instructions and video processing instructions to facilitate audio processing-related processes and functions and video processing-related processes and functions, respectively.

Each of the above identified instructions and applications can correspond to a set of instructions for performing one or more functions described above. These instructions need not be implemented as separate software programs, procedures, or modules. The memory 2650 can include additional instructions or fewer instructions. Furthermore, various functions of the computing device 2600 can be implemented in hardware and/or in software, including in one or more signal processing and/or application specific integrated circuits.

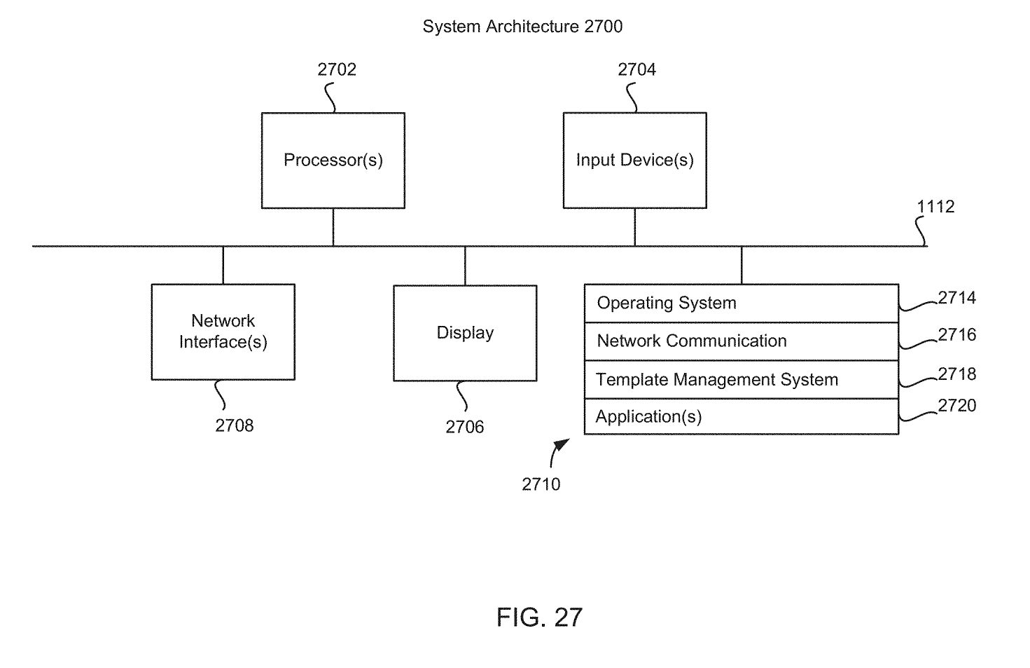

FIG. 27 is a block diagram of an example system architecture implementing the features and processes of FIGS. 1-25P. The architecture 2700 may be implemented on any electronic device that runs software applications derived from compiled instructions, including without limitation personal computers, servers, smart phones, media players, electronic tablets, game consoles, email devices, etc. In some implementations, the architecture 2700 may include one or more processors 2702, one or more input devices 2704, one or more display devices 2706, one or more network interfaces 2708, and one or more computer-readable mediums 2710. Each of these components may be coupled by bus 2712.

Display device 2706 may be any known display technology, including but not limited to display devices using Liquid Crystal Display (LCD) or Light Emitting Diode (LED) technology. Processor(s) 2702 may use any known processor technology, including but not limited to graphics processors and multi-core processors. Input device 2704 may be any known input device technology, including but not limited to a keyboard (including a virtual keyboard), mouse, track ball, and touch-sensitive pad or display. Bus 2712 may be any known internal or external bus technology, including but not limited to ISA, EISA, PCI, PCI Express, NuBus, USB, Serial ATA or FireWire. Computer-readable medium 2710 may be any medium that participates in providing instructions to processor(s) 2702 for execution, including without limitation, non-volatile storage media (e.g., optical disks, magnetic disks, flash drives, etc.), or volatile media (e.g., SDRAM, ROM, etc.).

Computer-readable medium 2710 may include various instructions 2714 for implementing an operating system (e.g., Mac OS®, Windows®, Linux). The operating system may be multi-user, multiprocessing, multitasking, multithreading, real-time, and the like. The operating system may perform basic tasks, including but not limited to: recognizing input from input device 2704; sending output to display device 2706; keeping track of files and directories on computer-readable medium 2710; controlling peripheral devices (e.g., disk drives, printers, etc.) which can be controlled directly or through an I/O controller; and managing traffic on bus 2712. Network communications instructions 2716 may establish and maintain network connections (e.g., software for implementing communication protocols, such as TCP/IP, HTTP, Ethernet, etc.).

A template management system 2718 can include instructions that may generate and provide interfaces and tools for template management and instructions for template distribution that use or implement the processes described in reference to FIGS. 1-25P. Application(s) 2720 may be an application that uses or implements the processes described in reference to FIGS. 1-25P. The processes may also be implemented in operating system 2714.

The described features may be implemented in one or more computer programs that may be executable on a programmable system including at least one programmable processor coupled to receive data and instructions from, and to transmit data and instructions to, a data storage system, at least one input device, and at least one output device. A computer program is a set of instructions that can be used, directly or indirectly, in a computer to perform a certain activity or bring about a certain result. A computer program may be written in any form of programming language (e.g., Objective-C, Java), including compiled or interpreted languages, and it may be deployed in any form, including as a stand-alone program or as a module, component, subroutine, or other unit suitable for use in a computing environment.

Suitable processors for the execution of a program of instructions may include, by way of example, both general and special purpose microprocessors, and the sole processor or one of multiple processors or cores, of any kind of computer. Generally, a processor may receive instructions and data from a read-only memory or a random access memory or both. The essential elements of a computer may include a processor for executing instructions and one or more memories for storing instructions and data. Generally, a computer may also include, or be operatively coupled to communicate with, one or more mass storage devices for storing data files; such devices include magnetic disks, such as internal hard disks and removable disks; magneto-optical disks; and optical disks. Storage devices suitable for tangibly embodying computer program instructions and data may include all forms of non-volatile memory, including by way of example semiconductor memory devices, such as EPROM, EEPROM, and flash memory devices; magnetic disks such as internal hard disks and removable disks; magneto-optical disks; and CD-ROM and DVD-ROM disks. The processor and the memory may be supplemented by, or incorporated in, ASICs (application-specific integrated circuits).

To provide for interaction with a user, the features may be implemented on a computer having a display device such as a CRT (cathode ray tube) or LCD (liquid crystal display) monitor for displaying information to the user and a keyboard and a pointing device such as a mouse or a trackball by which the user can provide input to the computer.

The features may be implemented in a computer system that includes a back-end component, such as a data server, or that includes a middleware component, such as an application server or an Internet server, or that includes a front-end component, such as a client computer having a graphical user interface or an Internet browser, or any combination of them. The components of the system may be connected by any form or medium of digital data communication such as a communication network. Examples of communication networks include, e.g., a LAN, a WAN, and the computers and networks forming the Internet.

The computer system may include clients and servers. A client and server may generally be remote from each other and may typically interact through a network. The relationship of client and server may arise by virtue of computer programs running on the respective computers and having a client-server relationship to each other.

One or more features or steps of the disclosed embodiments may be implemented using an API. An API may define one or more parameters that are passed between a calling application and other software code (e.g., an operating system, library routine, function) that provides a service, that provides data, or that performs an operation or a computation.

The API may be implemented as one or more calls in program code that send or receive one or more parameters through a parameter list or other structure based on a call convention defined in an API specification document. A parameter may be a constant, a key, a data structure, an object, an object class, a variable, a data type, a pointer, an array, a list, or another call. API calls and parameters may be implemented in any programming language. The programming language may define the vocabulary and calling convention that a programmer will employ to access functions supporting the API.

In some implementations, an API call may report to an application the capabilities of a device running the application, such as input capability, output capability, processing capability, power capability, communications capability, etc.

In some implementations, backend systems may comprise at least a MongoDB database and Parse server hosted in Amazon (AWS) and in Compose.io (an IBM company).

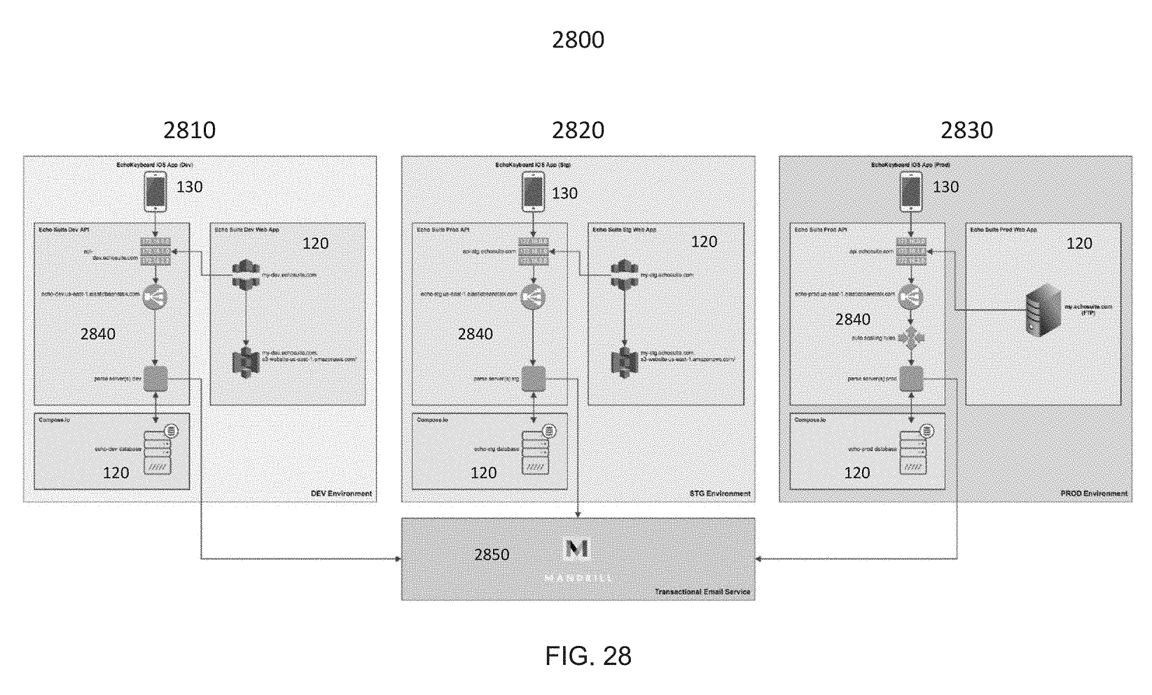

FIG. 28 is an example architecture 2800 configured to implement the features and processes of FIGS. 1-25P. Architecture 2800 may include three backend environments, development environment 2810, staging environment 2820, and production environment 2830. Development environment 2810 may be used by system developers for creating and testing the features and processes of FIGS. 1-25P. Staging environment 2820 may be used by system developers for debugging and testing the features and processes of FIGS. 1-25P. Production environment 2830 may be used by system users for using the features and processes of FIGS. 1-25P. In each environment, one or more client devices 130 may interact with backend systems (e.g., distribution servers 120) through an API 2840. In the examples of FIG. 28, each environment allows API 2840 to connect to two different distribution server 120 types (e.g., hosted by different providers such as Amazon or Composite.io). APIs 2840 may differ across environments in some embodiments. For example, API 2840 for production environment 2830 may include auto scaling features to allow any number of client devices 130 to connect with backend systems without overwhelming the systems. Distribution servers 120 may use notification services 2850 (e.g., Mandrill email service) to push data such as notifications to recipients as described above in some embodiments.

While various embodiments have been described above, it should be understood that they have been presented by way of example and not limitation. It will be apparent to persons skilled in the relevant art(s) that various changes in form and detail can be made therein without departing from the spirit and scope. In fact, after reading the above description, it will be apparent to one skilled in the relevant art(s) how to implement alternative embodiments.

In addition, it should be understood that any figures that highlight the functionality and advantages are presented for example purposes only. The disclosed methodologies and systems are each sufficiently flexible and configurable such that they may be utilized in ways other than that shown.

Although the term “at least one” may often be used in the specification, claims and drawings, the terms “a”, “an”, “the”, “said”, etc. also signify “at least one” or “the at least one” in the specification, claims, and drawings.

Finally, it is the applicant's intent that only claims that include the express language “means for” or “step for” be interpreted under 35 U.S.C. 112(f). Claims that do not expressly include the phrase “means for” or “step for” are not to be interpreted under 35 U.S.C. 112(f).

What is claimed is:

1. A method comprising:
receiving, at a distribution server comprising a processor and a database, data configured to modify at least one interface of at least one client device and distribution data;
storing, by the distribution server, the data in the database;
determining, by the distribution server, each at least one client device to which the data is to be delivered based on the distribution data; and
synchronizing, by the distribution server, the data in the database with each at least one client device to which the data is to be delivered.

2. The method of claim 1, wherein the data is received from a manager system configured to create and/or edit the data.

3. The method of claim 2, wherein the manager system is one of the at least one client devices.

4. The method of claim 1, wherein the distribution data defines at least one user and/or at least one client device authorized to receive the data.

5. The method of claim 1, wherein the data is configured to modify the at least one interface of the at least one client device by providing pre-generated content for placing into messages through the at least one interface.

6. The method of claim 1, further comprising sending, by the distribution server, at least one notification to each at least one client device to which the data is to be delivered prior to the synchronizing.

7. The method of claim 6, wherein the at least one notification comprises an email, a text message, or an inter-system notification, or a combination thereof.

8. The method of claim 1, wherein the synchronizing comprises pushing the data from the database to each at least one client device to which the data is to be delivered.

9. The method of claim 1, wherein the synchronizing comprises:
receiving a synchronization request from at least one client device to which the data is to be delivered; and
in response to the request, sending the data from the database to the requesting client device.

10. The method of claim 1, wherein the at least one interface comprises a soft keyboard or a menu.

11. The method of claim 1, wherein the data is configured to modify the at least one interface by updating data already available through the at least one interface.

12. The method of claim 1, wherein the data comprises existing content received from a third party.

13. A method comprising:
receiving, at a client device comprising a processor and a memory, data defining pre-generated content for placing into messages through at least one interface of the client device from a distribution server, the client device receiving the data based on being identified based on distribution data sent to the distribution server;
storing, by the client device, the data in the memory; and
modifying, by the client device, the at least one interface of the client device in accordance with the data.

14. The method of claim 13, wherein the client device is one of a plurality of client devices identified in the distribution data and receiving the data from the distribution server.

15. The method of claim 13, further comprising:
generating, by the client device, the data; and
sending, by the client device, the data to the distribution server.

16. The method of claim 13, further comprising sending, by the client device, a message comprising at least a portion of the data to a remote device.

17. The method of claim 16, further comprising receiving, by the client device, a user edit to the portion of the data prior to the sending.

18. The method of claim 13, further comprising receiving, by the client device, at least one notification from the distribution server prior receiving the data.

19. The method of claim 18, wherein the at least one notification comprises an email, a text message, or an inter-system notification, or a combination thereof.

20. The method of claim 18, further comprising sending, by the client device, a synchronization request to the distribution server, wherein the distribution server is configured to send the data to the client device in response to the request.

21. The method of claim 13, wherein the at least one interface comprises a soft keyboard or a menu.

22. The method of claim 13, wherein the data is configured to modify the at least one interface by updating data already available through the at least one interface.

23. A system comprising:
a manager system comprising a processor and a memory, the manager system being configured to:
generate data configured to modify at least one interface;
generate distribution data defining permissions to receive the data; and
send the data to a distribution server; and
at least one client device comprising a processor and a memory, the at least one client device being configured to:
receive the data from the distribution server when the at least one client device is identified by the distribution server based on the distribution data; and
modify the at least one interface of the at least one client device in accordance with the data.

24. The system of claim 23, wherein the manager system and one of the at least one client devices are the same device.

25. The system of claim 23, wherein:
the at least one client device comprises a plurality of client devices; and
the plurality of client devices synchronize interfaces through receiving the data and modifying the at least one interface.

26. The system of claim 23, wherein the at least one client device is further configured to send a message comprising at least a portion of the data to a remote device.

27. The system of claim 23, wherein:
the at least one client device is further configured to send a synchronization request to the distribution server; and
the distribution server is configured to send the data to the client device in response to the request.

28. The system of claim 23, wherein the at least one interface comprises a soft keyboard or a menu.

29. The system of claim 23, wherein the data is configured to modify the at least one interface by updating data already available through the at least one interface.

30. The system of claim 23, wherein the data comprises existing content received from a third party.
